(19) United States
(12) Patent Application Publication
(10) Pub. No.: US 2012/0170545 A1
(43) Pub. Date: Jul. 5, 2012

(54) BASE STATION APPARATUS

(75) Inventor: Takashi Yamamoto, Osaka-shi (JP)

(73) Assignee: Sumitomo Electric Industries, Ltd., Osaka-shi (JP)

(21) Appl. No.: 13/496,233

(22) PCT Filed: Nov. 8, 2010
(86) PCT No.: PCT/JP2010/069822

§ 371 Date: Mar. 15, 2012

(30) Foreign Application Priority Data
Nov. 10, 2009 (JP) 2009-257344
Nov. 11, 2009 (JP) 2009-258165

(51) Int. Cl. H04W 72/04; H04W 56/00; H04W 24/00

(52) U.S. Cl. 370/330

(57) ABSTRACT

Basic units (resource blocks) of resource allocation that can be used in a communication area of a base station apparatus are determined without obtaining resource allocation information. To do so, a base station apparatus includes an RF unit 4 that receives a communication signal between another base station apparatus and a terminal apparatus wirelessly connected to the another base station apparatus; a synchronization processing unit 5b that performs a process for synchronizing with the another base station apparatus; and a measurement processing unit 5d that determines power in each resource block of the communication signal received by the RF unit 4 and determines, based on the power, whether the resource block can be used in a communication area of the base station apparatus.

### TECHNICAL FIELD

The present invention relates to a base station apparatus that performs wireless communication with terminal apparatuses.

### BACKGROUND ART

Multiple base station apparatuses that perform wireless communication with terminal apparatuses are installed in order to cover a wide range of area. At this time, inter-base-station synchronization where synchronization of the timing of a radio frame is achieved between a plurality of base station apparatuses may be performed.

For example, Patent Literature 1 discloses that a certain base station apparatus performs inter-base-station synchronization using signals transmitted from another base station apparatus serving as a synchronization source. Although this Patent Literature 1 discloses the case where communication between a base station apparatus and terminal apparatuses is performed by Time Division Duplex (TDD), inter-base-station synchronization may be performed even in the case in which communication with terminal apparatuses is performed by Frequency Division Duplex (FDD).

### CITATION LIST

### Patent Literature

Patent Literature 1: Japanese Unexamined Patent Publication No. 2009-177532

### SUMMARY OF INVENTION

### Technical Problem

The case of performing inter-base-station synchronization includes, for example, the case of installing a new base station apparatus in a communication area of an already installed base station apparatus. At this time, it is desirable that a base station apparatus be newly installed with a minimal influence on communication of the already installed base station apparatus.

Specifically, in a communication system including such base station apparatuses, e.g., a system for mobile phones to which LTE (Long Term Evolution) is applied, in order to prevent interference in communication between a base station apparatus and terminal apparatuses, communication is performed such that resource blocks which are a plurality of basic units of resource allocation into which a radio frame is divided are allocated to each of the terminal apparatuses. Therefore, in a situation in which communication is performed between an already installed base station apparatus and terminal apparatuses, with resource blocks being allocated, if a newly installed base station apparatus performs wireless transmission without taking into account the already set resource block allocation, then interference may occur in the terminal apparatuses. Hence, to newly install a base station apparatus without causing such a problem, the newly installed base station apparatus needs to grasp resource block allocation for communication between an already installed base station apparatus and terminal apparatuses wirelessly connected thereto.

To grasp resource block allocation, resource allocation information (information on data allocation for each terminal apparatus) in a control channel included in a communication signal between an already installed base station apparatus and a terminal apparatus wirelessly connected thereto is obtained. However, to do so, a newly installed base station apparatus needs to, for example, establish communication with the already installed base station apparatus and also requires various signal processing.

An object of the present invention is therefore to provide a base station apparatus capable of determining usable basic units of resource allocation (e.g., resource blocks) without obtaining resource allocation information (a first object).

Furthermore, an object of the present invention is to provide a base station apparatus capable of determining usable basic units of resource allocation (e.g., resource blocks) without obtaining resource allocation information, and capable of appropriately communicating with terminal apparatuses present in its communication area (a second object).

### Solution to Problem

(1) For the above-described first object, the present invention is directed to a base station apparatus that communicates with a terminal apparatus present in a communication area thereof, using a plurality of basic units of resource allocation into which a radio frame is divided, the base station apparatus including: a receiving unit that receives a communication signal between another base station apparatus and a terminal apparatus wirelessly connected to the another base station apparatus; a synchronization processing unit that performs a process for synchronizing with the another base station apparatus; and a measurement processing unit that determines power in each basic unit of resource allocation of the communication signal received by the receiving unit and determines, based on the power, whether the basic unit of resource allocation can be used in the communication area of the base station apparatus.

According to the present invention, by the synchronization processing unit performing a process for synchronizing with another base station apparatus, basic units of resource allocation of a communication signal between another base station apparatus and a terminal apparatus wirelessly connected to the another base station apparatus can be determined. Then, the receiving unit receives a communication signal between another base station apparatus and a terminal apparatus wirelessly connected to the another base station apparatus, and the measurement processing unit determines power in each resource allocation unit of the communication signal and determines, based on the power, whether the basic unit of resource allocation can be used in the communication area of the base station apparatus. Thus, without obtaining resource allocation information included in the communication signal, basic units of resource allocation usable in the communication area of the base station apparatus can be determined.

Note that the above-described basic units of resource allocation are set complying with each individual communication standard. For example, in the case of a communication system to which LTE (Long Term Evolution) is applied, the basic units are resource blocks. In this case, as viewed in a time-axis direction, the same resource block is allocated to one same terminal apparatus for each subframe. In addition, a plurality of resource blocks arranged side by side in a consecutive manner in the time-axis direction are allocated to one same terminal apparatus.

(2) It is preferred that the above-described base station apparatus include a resource allocation control unit that allocates the basic unit of resource allocation determined by the measurement processing unit to be usable in the communication area of the base station apparatus, as an area used to communicate with the terminal apparatus present in the communication area of the base station apparatus.

In this case, the base station apparatus can communicate with a terminal apparatus present in its communication area and can avoid exerting an influence on communication of another base station.

(3) Furthermore, it is preferred that the base station apparatus including the resource allocation control unit include a communication condition control unit that controls a communication condition used when performing wireless communication using the basic unit of resource allocation allocated by the resource allocation control unit.

In this case, for example, in accordance with a communication environment, a communication condition can be changed for each basic unit of resource allocation allocated as an area usable in the communication area of the base station apparatus. Note that the transmission condition includes the magnitude of transmit power, a modulation scheme, a code rate, or the like.

(4) In addition, the measurement processing unit may start the above-described determination process for each synchronization process performed by the synchronization processing unit, but the configuration may be such that the synchronization processing unit starts the process for synchronization in a first cycle, and the measurement processing unit determines, based on the power, whether the basic unit of resource allocation can be used in the communication area of the base station apparatus, in a second cycle different than the first cycle.

In this case, when the frequency of requirement for a synchronization process by the synchronization processing unit differs from the frequency of requirement for a process of determining a communication state by the measurement processing unit, their respective cycles can be made different in accordance with the frequencies of requirement.

(5) In addition, if the timing of a radio frame of another base station apparatus can be grasped, i.e., if synchronization can be achieved, then the measurement processing unit can determine basic units of resource allocation. Thus, the measurement processing unit may be configured to determine, based on the power, whether the basic unit of resource allocation can be used in the communication area of the base station apparatus, after starting the process for synchronization performed by the synchronization processing unit.

(6) In addition, in each of the above-described base station apparatuses, the communication signal received by the receiving unit so as to be used by the measurement processing unit is a downlink signal transmitted by the another base station apparatus to the terminal apparatus wirelessly connected to the another base station apparatus.

(7) Alternatively, the communication signal received by the receiving unit so as to be used by the measurement processing unit is an uplink signal transmitted by the terminal apparatus wirelessly connected to the another base station apparatus to the another base station apparatus.

(8) As described above, a plurality of basic units of resource allocation arranged side by side in a consecutive manner in the time-axis direction are normally allocated to one same terminal apparatus. However, due to, for example, an increase in the number of terminal apparatuses, the allocation position of a basic unit of resource allocation allocated to be used by a certain terminal apparatus may change, for example, every radio frame (the allocation position in a frequency direction changes every radio frame) and thus become variable.

In such a case, too, if, in a certain radio frame, the resource allocation control unit allocates the basic unit of resource allocation determined by the measurement processing unit to be usable in the communication area of the base station apparatus, as an area used to communicate with the terminal apparatus present in the communication area of the base station apparatus, then interference may occur in later radio frames.

In view of this, it is preferred that the base station apparatus including the resource allocation control unit include an allocation determining unit that determines, based on the communication signal transmitted such that allocation of basic units of resource allocation is performed by the another base station apparatus, whether the allocation is variable or fixed.

According to this base station apparatus, the allocation determining unit can determine whether allocation of basic units of resource allocation performed by another base station apparatus is variable or fixed.

(9) Then, when the allocation determining unit determines that the allocation is fixed, the resource allocation control unit allocates the basic unit of resource allocation determined by the measurement processing unit to be usable in the communication area of the base station apparatus, as an area used to communicate with the terminal apparatus present in the communication area of the base station apparatus.

As such, when the allocation is fixed, the base station apparatus can communicate with a terminal apparatus present in its communication area, using basic units of resource allocation determined to be usable. Moreover, since the basic units of resource allocation determined to be usable are considered to be also usable later, the transmit power to the terminal apparatus does not need to be reduced and it is possible to avoid exerting an influence on communication of another base station apparatus.

(10) On the other hand, when the allocation determining unit determines that the allocation is variable, the allocation determining unit allows performing communication with transmit power to a terminal apparatus present in the communication area of the base station apparatus being reduced.

As such, when the allocation is variable, by reducing the transmit power to a terminal apparatus present in the communication area of the base station apparatus, the occurrence of interference is prevented, making it possible to avoid exerting an influence on communication of another base station apparatus.

(11) In addition, in the base station apparatus including the allocation determining unit, the allocation determining unit can determine whether the allocation is variable or fixed, based on a statistical value of power in the basic unit of resource allocation of the communication signal received by the receiving unit. For example, as the statistical value, a variance of power in a basic unit of resource allocation is determined, and if the value of the variance is large, then it is considered that the value of power in the basic unit of resource allocation has variations, and thus, it can be determined that the allocation is variable. On the other hand, if the value of the variance is small, then it is considered that variations thereof are small, and thus, it can be determined that the allocation is fixed.

Note that in the base station apparatuses in the above-described (8) to (11), another base station apparatus allocates basic units of resource allocation used by terminal apparatuses wirelessly connected to the another base station apparatus. This allocation being variable refers to a state in which the allocation positions of basic units of resource allocation allocated to one same terminal apparatus are in different positions in the frequency direction. Namely, being variable refers to the case in which the degree of variations in allocation is higher than a preset threshold value.

On the other hand, the allocation being fixed refers to a state in which the allocation positions of basic units of resource allocation allocated to one same terminal apparatus are in the same position in the frequency direction. Note that the same position includes the case in which the degree of being in different positions is low. That is, being fixed refers to the case in which the degree of variations in allocation is lower than the preset threshold value.

(12) The present invention is directed to a base station apparatus that communicates with a terminal apparatus present in a communication area thereof, using a plurality of basic units of resource allocation into which a radio frame is divided, the base station apparatus including: a transmitting/receiving unit that can receive a downlink signal transmitted from another base station apparatus to a terminal apparatus wirelessly connected to the another base station apparatus and that transmits a downlink signal to the terminal apparatus present in the communication area of the base station apparatus; and a measurement processing unit that determines power in each basic unit of resource allocation of the downlink signal received by the transmitting/receiving unit and determines, based on the power, whether the basic unit of resource allocation can be used in the communication area of the base station apparatus, wherein with transmission of the downlink signal by the transmitting/receiving unit being temporarily suspended, the measurement processing unit determines, based on the power of the downlink signal received by the transmitting/receiving unit, whether the basic unit of resource allocation can be used in the communication area of the base station apparatus.

According to the present invention, the transmitting/receiving unit receives a downlink signal transmitted from another base station apparatus to a terminal apparatus wirelessly connected to the another base station apparatus, and the measurement processing unit determines power in each resource allocation unit of the received downlink signal and determines, based on the power, whether the basic unit of resource allocation can be used in the communication area of the base station apparatus. Thus, without obtaining resource allocation information included in the downlink signal from another base station apparatus, basic units of resource allocation usable in the communication area of the base station apparatus can be determined.

However, at this time, downlink signals received by the transmitting/receiving unit may include a downlink signal transmitted to a terminal apparatus present in the communication area of the base station apparatus, in addition to a downlink signal transmitted from another base station apparatus to a terminal apparatus. Thus, when the measurement processing unit makes the above-described determination based on the power of a downlink signal, a downlink signal transmitted by the base station apparatus may become trouble.

In view of this, according to the present invention, by brining transmission of a downlink signal by the transmitting/receiving unit to a temporarily suspended state, the measurement processing unit can make the above-described determination based on a downlink signal transmitted from another base station apparatus to a terminal apparatus and received by the transmitting/receiving unit, making it possible to prevent the above-described trouble.

(13) In addition, the present invention is directed to a base station apparatus that communicates with a terminal apparatus present in a communication area thereof, using a plurality of basic units of resource allocation into which a radio frame is divided, the base station apparatus including: a receiving unit that receives a communication signal between another base station apparatus and a terminal apparatus wirelessly connected to the another base station apparatus; a synchronization processing unit that performs a process for synchronizing with the another base station apparatus; and a measurement processing unit that determines communication quality in each basic unit of resource allocation of the communication signal received by the receiving unit and determines, based on the communication quality, whether the basic unit of resource allocation can be used in the communication area of the base station apparatus.

According to the present invention, by the synchronization processing unit performing a process for synchronizing with another base station apparatus, basic units of resource allocation of a communication signal between another base station apparatus and a terminal apparatus wirelessly connected to the another base station apparatus can be determined. Then, the receiving unit receives a communication signal between another base station apparatus and a terminal apparatus wirelessly connected to the another base station apparatus, and the measurement processing unit determines communication quality in each resource allocation unit of the communication signal and determines, based on the communication quality, whether the basic unit of resource allocation can be used in the communication area of the base station apparatus. Thus, without obtaining resource allocation information included in the communication signal, basic units of resource allocation usable in the communication area of the base station apparatus can be determined.

(14) In addition, the present invention is directed to a base station apparatus that communicates with a terminal apparatus present in a communication area thereof, using a plurality of basic units of resource allocation into which a radio frame is divided, the base station apparatus including: a transmitting/receiving unit that can receive a downlink signal transmitted from another base station apparatus to a terminal apparatus wirelessly connected to the another base station apparatus and that transmits a downlink signal to the terminal apparatus present in the communication area of the base station apparatus; and a measurement processing unit that determines communication quality in each basic unit of resource allocation of the downlink signal received by the transmitting/receiving unit and determines, based on the communication quality, whether the basic unit of resource allocation can be used in the communication area of the base station apparatus, wherein with transmission of the downlink signal by the transmitting/receiving unit being temporarily suspended, the measurement processing unit determines, based on the communication quality of the downlink signal received by the transmitting/receiving unit, whether the basic unit of resource allocation can be used in the communication area of the base station apparatus.

According to the present invention, the transmitting/receiving unit receives a downlink signal transmitted from another base station apparatus to a terminal apparatus wirelessly connected to the another base station apparatus, and the measurement processing unit determines communication quality in each resource allocation unit of the received downlink signal and determines, based on the communication quality, whether the basic unit of resource allocation can be used in the communication area of the base station apparatus. Thus, without obtaining resource allocation information included in the downlink signal from another base station apparatus, basic units of resource allocation usable in the communication area of the base station apparatus can be determined.

However, at this time, downlink signals received by the transmitting/receiving unit may include a downlink signal transmitted to a terminal apparatus present in the communication area of the base station apparatus, in addition to a downlink signal transmitted from another base station apparatus to a terminal apparatus. Thus, when the measurement processing unit makes the above-described determination based on the communication quality of a downlink signal, a downlink signal transmitted by the base station apparatus may become trouble.

In view of this, according to the present invention, by brining transmission of a downlink signal by the transmitting/receiving unit to a temporarily suspended state, the measurement processing unit can make the above-described determination based on a downlink signal transmitted from another base station apparatus to a terminal apparatus and received by the transmitting/receiving unit, making it possible to prevent the above-described trouble.

In addition, the configurations in the above-described (2) to (11) can also be applied to the base station apparatuses described in the above-described (13) and (14). In this case, the “power in the basic unit of resource allocation” in each configuration is read as “communication quality in the basic unit of resource allocation”.

(15) For the above-described second object, the present invention is directed to a base station apparatus that communicates with a terminal apparatus present in a communication area thereof, using a plurality of basic units of resource allocation into which a radio frame is divided, the base station apparatus including: a transmitting/receiving unit that receives a communication signal between another base station apparatus and a terminal apparatus wirelessly connected to the another base station apparatus and that is to communicate with the terminal apparatus present in the communication area of the base station apparatus; a synchronization processing unit that performs a process for synchronizing with the another base station apparatus; a measurement processing unit that determines power in each basic unit of resource allocation of the communication signal received by the transmitting/receiving unit and determines, based on the power, whether the basic unit of resource allocation can be used in the communication area of the base station apparatus; a changing unit that can change, based on a result of the determination by the measurement processing unit, a way to use the basic unit of resource allocation in order to communicate with the terminal apparatus present in the communication area of the base station apparatus; and a determination processing unit that determines whether the change to the way to use is appropriate, based on a difference between powers in the basic unit of resource allocation before and after the change, the powers being determined by the measurement processing unit before and after the change to the way to use made by the changing unit.

According to the present invention, by the synchronization processing unit performing a process for synchronizing with another base station apparatus, basic units of resource allocation of a communication signal between another base station apparatus and a terminal apparatus wirelessly connected to the another base station apparatus can be determined. Then, the transmitting/receiving unit receives a communication signal between another base station apparatus and a terminal apparatus wirelessly connected to the another base station apparatus, and the measurement processing unit determines power in each resource allocation unit of the communication signal and determines, based on the power, whether the basic unit of resource allocation can be used in the communication area of the base station apparatus. Thus, without obtaining resource allocation information included in the communication signal, basic units of resource allocation usable in the communication area of the base station apparatus can be determined.

Then, based on a result of the determination by the measurement processing unit, the changing unit changes the way to use the basic unit of resource allocation in order to communicate with the terminal apparatus present in the communication area of the base station apparatus, and then communication can be performed with the terminal apparatus.

When supposedly the determination made by the measurement processing unit is wrong, e.g., a certain basic unit of resource allocation is determined to be usable despite the fact that the basic unit is actually not usable, and the changing unit changes the way to use the basic unit of resource allocation and then the base station apparatus performs, using the basic unit of resource allocation, communication with a terminal apparatus present in its communication area, the communication state between another base station apparatus and a terminal apparatus wirelessly connected to the another base station apparatus may deteriorate. Thus, in an attempt to improve the communication state, another base station apparatus, for example, increases transmit power. This results in an increase in power in the basic unit of resource allocation of a communication signal transmitted from this another base station apparatus, and thus, power determined by the measurement processing unit also changes in an increasing manner.

Hence, the determination processing unit determines, based on a difference between powers before and after a change to the way to use a basic unit of resource allocation made by the changing unit, whether the change to the way to use is appropriate, and thus, can find a determination error made by the measurement processing unit.

(16) In addition, in the above-described base station apparatus, when the difference between powers before and after the change to the way to use the basic unit of resource allocation made by the changing unit exceeds a threshold value, the determination processing unit determines that the change to the way to use is inappropriate and thus can perform a process of invalidating the change to the way to use.

In this case, as described above, because of an erroneous determination by the measurement processing unit, although the changing unit changes the way to use a basic unit of resource allocation, the change is invalidated. Hence, the way to use the basic unit of resource allocation can be brought back to a state obtained before the change, making it possible to suppress an influence exerted on communication of another base station apparatus.

(17) In addition, in the above-described base station apparatus, when the difference between powers before and after the change to the way to use the basic unit of resource allocation made by the changing unit is less than or equal to the threshold value, the determination processing unit determines that the change to the way to use is appropriate and thus performs a process of validating the change to the way to use, and the transmitting/receiving unit can communicate with the terminal apparatus present in the communication area of the base station apparatus, by the way to use the basic unit of resource allocation having been changed by the changing unit.

In this case, even if the measurement processing unit properly determines that a certain basic unit of resource allocation of a communication signal between another base station apparatus and a terminal apparatus wirelessly connected to the another base station apparatus is usable, and thus, the changing unit changes the way to use the basic unit of resource allocation and then communication is performed with a terminal apparatus using the basic unit of resource allocation, the basic unit of resource allocation does not affect communication of another base station apparatus. Hence, in the basic unit of resource allocation of the communication signal, there are no large variations in power before and after the change to the way to use the basic unit of resource allocation and the difference between the powers is less than or equal to the threshold value, and thus, the determination processing unit validates the change to the way to use the basic unit of resource allocation. Then, the transmitting/receiving unit can appropriately communicate with a terminal apparatus present in the communication area of the base station apparatus, by the changed way to use the basic unit of resource allocation.

(18) In addition, the changing unit has a resource allocation function for changing the way to use the basic unit of resource allocation, and the resource allocation function allocates a basic unit of resource allocation determined by the measurement processing unit to be usable in the communication area of the base station apparatus, as an area used to communicate with the terminal apparatus present in the communication area of the base station apparatus.

In this case, communication can be performed with the terminal apparatus using the basic unit of resource allocation, and moreover, the influence of communication in another base station apparatus can be suppressed.

(19) In addition, the changing unit has a communication condition control function for changing the way to use the basic unit of resource allocation, and the communication condition control function increases transmit power of a signal to be transmitted to the terminal apparatus from the transmitting/receiving unit, in the basic unit of resource allocation determined by the measurement processing unit to be usable in the communication area of the base station apparatus.

In this case, by increasing the transmit power of a signal transmitted from the transmitting/receiving unit, the state of communication with a terminal apparatus present in the communication area of the base station apparatus improves, and moreover, the influence of communication in another base station apparatus can be suppressed.

(20) In addition, the present invention is directed to a base station apparatus that communicates with a terminal apparatus present in a communication area thereof, using a plurality of basic units of resource allocation into which a radio frame is divided, the base station apparatus including: a transmitting/receiving unit that receives a communication signal between another base station apparatus and a terminal apparatus wirelessly connected to the another base station apparatus and that is to communicate with the terminal apparatus present in the communication area of the base station apparatus; a synchronization processing unit that performs a process for synchronizing with the another base station apparatus; a measurement processing unit that determines communication quality in each basic unit of resource allocation of the communication signal received by the transmitting/receiving unit and determines, based on the communication quality, whether the basic unit of resource allocation can be used in the communication area of the base station apparatus; a changing unit that can change, based on a result of the determination by the measurement processing unit, a way to use the basic unit of resource allocation in order to communicate with the terminal apparatus present in the communication area of the base station apparatus; and a determination processing unit that determines whether the change to the way to use is appropriate, based on a difference between communication qualities in the basic unit of resource allocation before and after the change, the communication qualities being determined by the measurement processing unit before and after the change to the way to use made by the changing unit.

According to the present invention, by the synchronization processing unit performing a process for synchronizing with another base station apparatus, basic units of resource allocation of a communication signal between another base station apparatus and a terminal apparatus wirelessly connected to the another base station apparatus can be determined. Then, the transmitting/receiving unit receives a communication signal between another base station apparatus and a terminal apparatus wirelessly connected to the another base station apparatus, and the measurement processing unit determines communication quality in each resource allocation unit of the communication signal and determines, based on the communication quality, whether the basic unit of resource allocation can be used in the communication area of the base station apparatus. Thus, without obtaining resource allocation information included in the communication signal, basic units of resource allocation usable in the communication area of the base station apparatus can be determined.

Then, based on a result of the determination by the measurement processing unit, the changing unit changes the way to use the basic unit of resource allocation in order to communicate with the terminal apparatus present in the communication area of the base station apparatus, and then communication can be performed with the terminal apparatus.

When supposedly the determination made by the measurement processing unit is wrong, e.g., a certain basic unit of resource allocation is determined to be usable despite the fact that the basic unit is actually not usable, and the changing unit changes the way to use the basic unit of resource allocation and then the base station apparatus performs, using the basic unit of resource allocation, communication with a terminal apparatus present in its communication area, the communication state between another base station apparatus and a terminal apparatus wirelessly connected to the another base station apparatus may deteriorate. Thus, in an attempt to improve the communication state, another base station apparatus, for example, increases transmit power. This results in an improvement in communication quality in the basic unit of resource allocation of a communication signal transmitted from the another base station apparatus, and thus, communication quality determined by the measurement processing unit changes.

Hence, the determination processing unit determines, based on a difference between communication qualities before and after a change to the way to use a basic unit of resource allocation made by the changing unit, whether the change to the way to use is appropriate, and thus, can find a determination error made by the measurement processing unit.

The configurations in the above-described (16) to (19) can also be applied to the base station apparatus described in the above-described (20). In this case, the “power in the basic unit of resource allocation” in each configuration can be read as “communication quality in the basic unit of resource allocation”.

### BRIEF DESCRIPTION OF DRAWINGS

FIG. 1 is a schematic diagram showing a configuration of a wireless communication system according to Chapter 1.

FIG. 2 is a diagram showing the structures of uplink and downlink radio frames in LTE.

FIG. 3 is a diagram showing a detailed structure of a DL frame.

FIG. 4 is a block diagram showing a configuration of a femto base station.

FIG. 5 is a block diagram showing a detail of an RF unit.

FIG. 6 is a flowchart describing a synchronization process, a measurement process, and an allocation process.

FIG. 7 is a diagram for describing an example of a mode of a synchronization process performed by a synchronization processing unit.

FIG. 8 is a diagram for describing an example of a mode of a measurement process performed by a measurement processing unit.

FIG. 9 is a diagram showing an example of the results of obtaining, by the measurement processing unit, power average values for each of resource blocks.

FIG. 10 is a diagram for describing an example of a mode of a process performed by an allocation determining unit.

FIG. 11 is a diagram showing a structure of a UL frame.

FIG. 12 is a schematic diagram showing a configuration of a wireless communication system according to Chapter 2.

FIG. 13 is a diagram showing the structures of uplink and downlink radio frames in LTE.

FIG. 14 is a diagram showing a detailed structure of a DL frame.

FIG. 15 is a block diagram showing a configuration of a femto base station.

FIG. 16 is a block diagram showing a detail of an RF unit.

FIG. 17 is a flowchart describing a synchronization process, a measurement process, and an allocation process.

FIG. 18 is a diagram for describing an example of a mode of a synchronization process performed by a synchronization processing unit.

FIG. 19 is a diagram for describing an example of a mode of a measurement process performed by a measurement processing unit.

FIG. 20 is a diagram showing an example of the results of obtaining, by the measurement processing unit, power average values for each of resource blocks.

FIG. 21 is a diagram for describing an example of a mode of a determination process performed by a determination processing unit.

FIG. 22 is an illustrative diagram for the case in which a determination error by the measurement processing unit occurs.

FIG. 23 is a diagram for describing an example of a mode of a process performed by an allocation determining unit.

FIG. 24 is a diagram showing a structure of a UL frame.

### DESCRIPTION OF EMBODIMENTS

Preferred embodiments of the present invention will be described below with reference to the accompanying drawings.

[Chapter 1]

[1.1 Configuration of a Communication System]

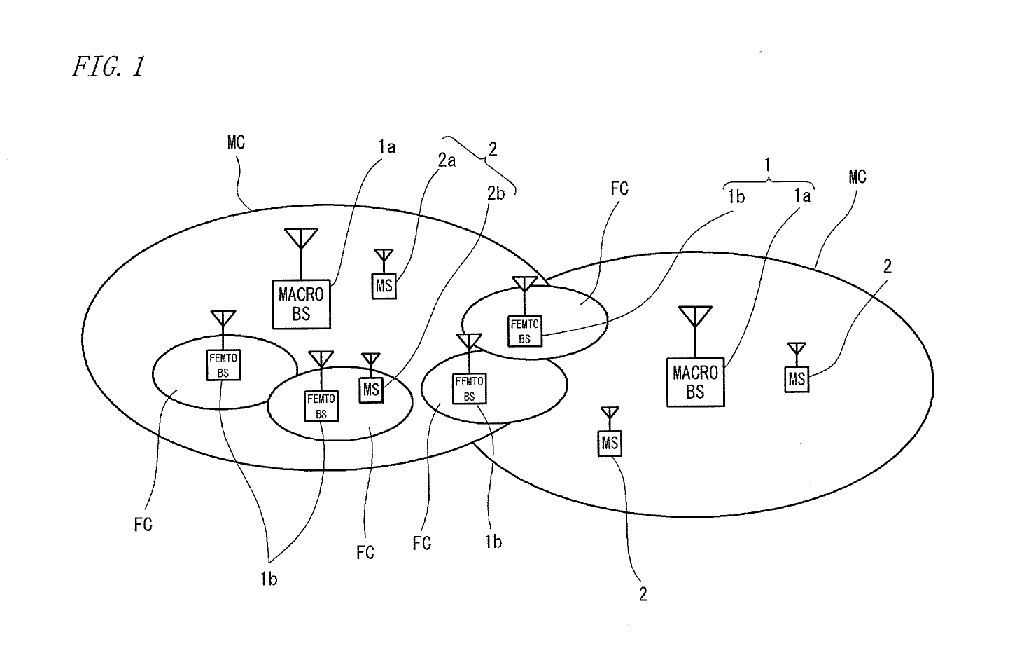

FIG. 1 is a schematic diagram showing a configuration of a wireless communication system according to Chapter 1.

The wireless communication system includes a plurality of base station apparatuses 1 and a plurality of terminal apparatuses 2 (mobile stations) that can perform wireless communication with the base station apparatuses 1.

The plurality of base station apparatuses 1 include, for example, a plurality of macro base stations la, each forming a communication area (macrocell) MC of several kilometers in size; and a plurality of femto base stations 1b, each installed in a macrocell MC and forming a relatively small communication area (femtocell) FC of the order of several tens of meters. The femto base stations 1b are base station apparatuses of the present invention.

Each macro base station 1a (hereinafter, also referred to as a macro BS 1a) can perform wireless communication with terminal apparatuses 2a (hereinafter, also referred to as MS 2a) present in its macrocell MC.

Each femto base station 1b (hereinafter, also referred to as a femto BS 1b) is disposed in, for example, a location where it is difficult to receive radio waves from a macro BS 1a, such as indoors, and can perform wireless communication with terminal apparatuses 2b (hereinafter, also referred to as MS 2b) present in its femtocell FC.

This system makes it possible to provide terminal apparatuses 2b with services with sufficient throughput even in a location where it is difficult to receive radio waves from a macro BS 1a, etc., by installing, in the location, a femto BS 1b which forms a relatively small femtocell FC.

In the wireless communication system, in order to prevent interference from occurring in communication between a macro BS 1a and terminal apparatuses 2 in a macrocell MC, a plurality of resource blocks into which a radio frame is divided are allocated for each terminal apparatus 2, and the terminal apparatuses 2 and the macro BS 1a perform communication in a state of being synchronized with each other, using the allocated resource blocks.

On the other hand, a femto BS 1b is installed, after installation of a macro BS 1a, in a macrocell MC formed by the macro BS 1a and forms a femtocell FC in the macrocell MC, and thus, interference, etc., may occur between terminal apparatuses 2a and 2b.

Hence, though described in detail later, each femto BS 1b has the function (monitoring function) of a measurement process in which it is determined, based on the state of communication between another base station apparatus, such as a macro BS 1a or a femto BS 1b other than itself, and terminal apparatuses 2a, i.e., the non-allocation state of resource blocks of signals used for the communication, etc., whether the resource blocks can be used in a communication area (femtocell FC) of the femto BS 1b; the function of allocating, based on results of the determination, unallocated resource blocks for communication of the femto BS 1b so as not to affect communication in a macrocell MC; and the function of performing control to change a communication condition such as transmit power or a modulation scheme. By these functions, the femto BS 1b can form a femtocell FC in the macrocell MC without affecting communication of another base station apparatus, and moreover secure its communication.

In addition, in the communication system of the present embodiment, inter-base-station synchronization is performed where synchronization of frame timing is achieved between a plurality of base station apparatuses including a macro BS 1a and a femto BS 1b. Inter-base-station synchronization is performed by “air synchronization” where synchronization is achieved by another base station apparatus receiving signals transmitted by a base station apparatus serving as a master (a synchronization source) to a terminal apparatus in a cell of the base station apparatus.

The base station apparatus serving as a master (a synchronization source) may achieve air synchronization with still another base station apparatus or may determine frame timing by other methods than air synchronization, such as autonomously determining frame timing by a GPS signal.

Note, however, that a macro BS 1a can have another macro BS 1a as a master but cannot have a femto BS 1b as a master. A femto BS 1b can have a macro BS 1a as a master and can also have another femto BS 1b as a master.

The wireless communication system of the present embodiment is, for example, a system for mobile phones to which LTE (Long Term Evolution) is applied, and communication complying with LTE is performed between each base station apparatus and terminal apparatuses. LTE adopts a Frequency Division Duplex (FDD) scheme. Note that the communication system is not limited in its standard to LTE and is not limited in its scheme to the FDD scheme and may adopt, for example, a TDD (Time Division Duplex) scheme.

[1.2 Frame Structure in LTE]

In the FDD scheme that can be adopted in LTE with which the communication system of the present embodiment complies, different usage frequencies are allocated to an uplink signal (also referred to as a UL signal) which is a transmit signal from a terminal apparatus 2 to a base station apparatus 1, and a downlink signal (also referred to as a DL signal) which is a transmit signal from the base station apparatus 1 to the terminal apparatus 2, whereby uplink communication and downlink communication are simultaneously performed.

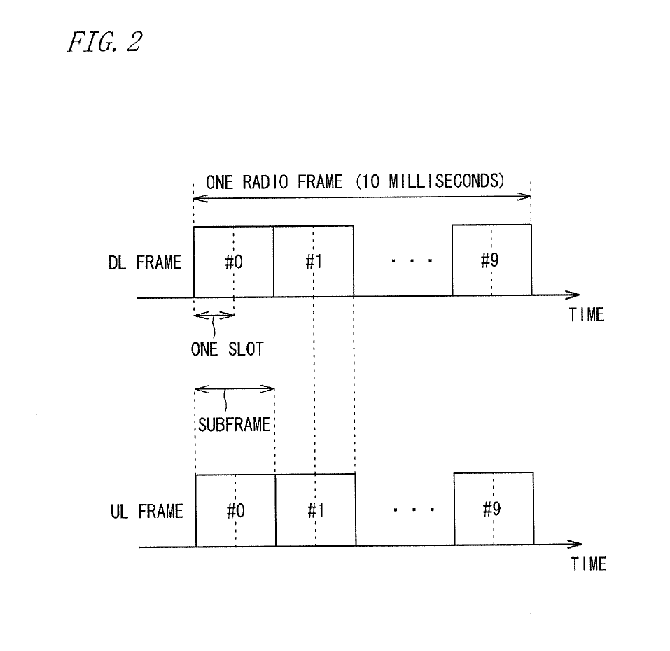

FIG. 2 is a diagram showing the structures of uplink and downlink radio frames in LTE. For a radio frame which is a basic frame on the downlink side (DL frame) in LTE and a radio frame on the uplink side (UL frame), each radio frame has a time length of 10 milliseconds and includes 10 subframes, #0 to #9 (each is a communication unit area having a fixed time length). These DL and UL frames managed by each base station apparatus are arranged in a time-axis direction such that their timings are aligned with each other.

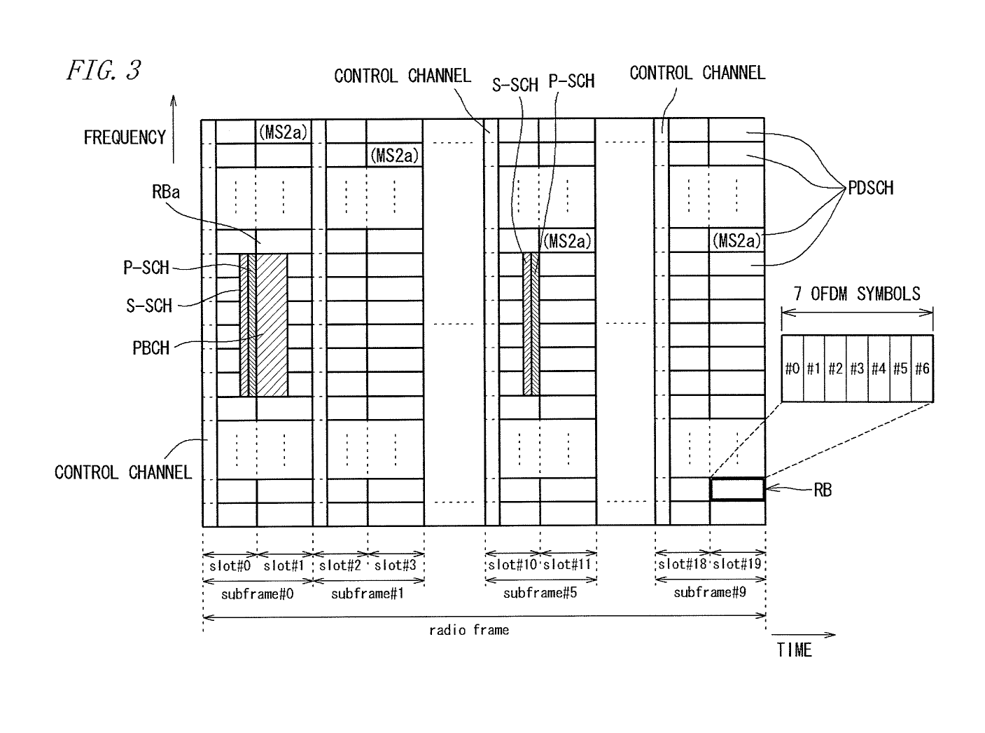

FIG. 3 is a diagram showing a detailed structure of a DL frame. In the drawing, a vertical-axis direction represents frequency and a horizontal-axis direction represents time. Each of the subframes forming a DL frame includes two slots (e.g., slots #0 and #1). One slot includes seven (#0 to #6) OFDM symbols (in the case of Normal Cyclic Prefix).

In addition, in the drawing, a resource block (RB) which is a basic unit of resource allocation (the minimum unit of resource allocation) is defined as having 12 subcarriers in the frequency-axis direction and 7 OFDM symbols (1 slot) in the time-axis direction. Therefore, for example, when the frequency bandwidth of a DL frame is set to 5 MHz, 300 subcarriers are arranged and thus 25 resource blocks are arranged in the frequency-axis direction. Resource blocks are a plurality of basic units of resource allocation into which a radio frame is divided in the time-axis direction and the frequency-axis direction on a subframe-by-subframe basis.

As shown in FIG. 3, the head of each subframe is assigned a control channel used by a base station apparatus to transmit information required for downlink communication to a terminal apparatus. A control channel is assigned using symbols #0 to #2 (three symbols at the maximum) in a slot located on the head side of each subframe. The control channel stores DL control information, resource allocation information for the subframe, etc.

In the DL frame, the first subframe #0 is assigned a Physical Broadcast Channel (PBCH) for notifying terminal apparatuses of a system bandwidth, etc., by broadcast transmission. The physical broadcast channel stores essential system information such as a communication bandwidth, the number of transmit antennas, and the structure of control information.

Of 10 subframes forming the DL frame, each of the first (#0) and sixth (#5) subframes is assigned a first synchronization signal and a second synchronization signal (P-SCH: Primary Synchronization Channel and S-SCH: Secondary Synchronization Channel) which are signals for identifying a base station apparatus and a cell.

For the first synchronization signal and the second synchronization signal, 504 types (168×3) of patterns are defined by combining them with each other. A terminal apparatus can recognize in which sector of which base station apparatus the terminal is present, by obtaining a first synchronization signal and a second synchronization signal which are transmitted from a base station apparatus.

A plurality of patterns that can be taken by the first synchronization signal and the second synchronization signal are predetermined in a communication standard and are known by each base station apparatus and each terminal apparatus. That is, the first synchronization signal and the second synchronization signal each are a known signal that can take a plurality of patterns.

As described above, a downlink signal is formed such that a plurality of subframes are arranged on a time axis, and the plurality of subframes forming the downlink signal include subframes including a first synchronization signal and a second synchronization signal and subframes not including those signals.

When the downlink signal is looked at on a subframe basis, the subframes (#0 and #5) each including a first synchronization signal and a second synchronization signal are arranged intermittently. In addition, a first synchronization signal and a second synchronization signal are arranged in the DL frame in the above-described manner and are thereby arranged cyclically in the downlink signal, with five subframes being one cycle.

The first synchronization signal and the second synchronization signal are used as signals not only for the case where a terminal apparatus achieves synchronization with a base station apparatus, but also for inter-base-station synchronization where communication timing (time) and/or frequency are/is synchronized between base station apparatuses, which will be described later.

Resource blocks in other areas where the above-described channels are not assigned (non-hatched areas in the drawing) are used as Physical Downlink Shared Channels (PDSCHs) for storing data, etc. for each terminal apparatus. The physical downlink shared channels are areas shared for communication performed by a plurality of terminal apparatuses, and store control information for individual terminal apparatuses, etc., in addition to data for each terminal apparatus.

Allocation of data for terminal apparatuses to be stored in physical downlink shared channels is defined by resource allocation information in the above-described control channel assigned to the head of each subframe. A terminal apparatus grasps resource allocation information by performing various processes on a received downlink signal (with communication being established) and can thereby determine whether data destined therefor is stored in the subframe.

[1.3 Configuration of a Femto Base Station]

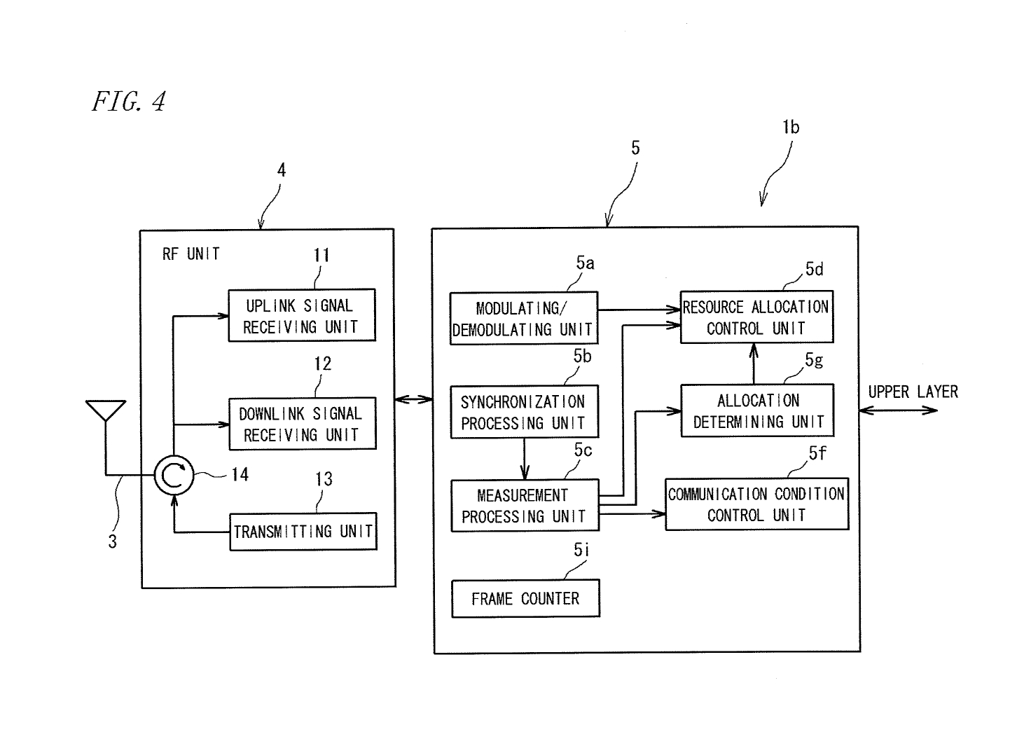

FIG. 4 is a block diagram showing a configuration of a femto BS 1b in FIG. 1. Note that here a configuration of a femto BS 1b will be described. The femto BS 1b includes an antenna 3; an RF unit (transmitting/receiving unit) 4 to which the antenna 3 is connected; and a signal processing unit 5 that performs a process for inter-base-station synchronization, a measurement process, a resource block allocation process, etc., in addition to signal processing of transmit and receive signals which are given and received to/from the RF unit 4. Note that the configuration of a macro BS 1a is substantially the same as that of the femto BS 1b in terms of the above points.

[1.3.1 RF Unit]

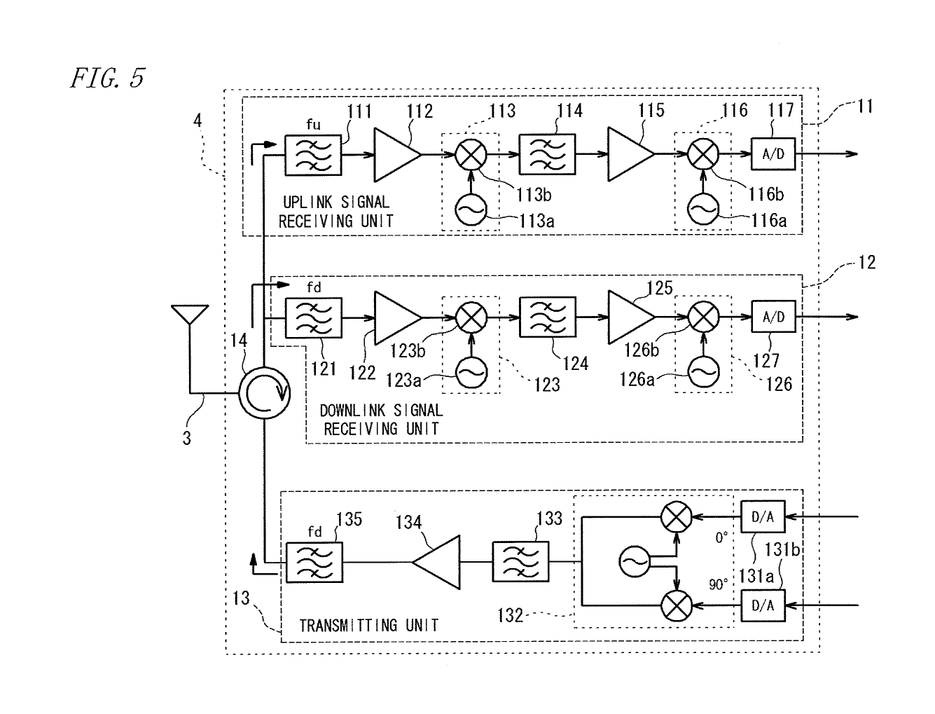

FIG. 5 is a block diagram showing a detail of the RF unit 4. The RF unit 4 includes an uplink signal receiving unit 11, a downlink signal receiving unit 12, and a transmitting unit 13. The uplink signal receiving unit 11 is to receive uplink signals with a frequency fᵤ from terminal apparatuses 2, and the transmitting unit 13 is to transmit downlink signals with a frequency f_{d} to the terminal apparatuses 2. The downlink signal receiving unit 12 is to receive a downlink signal with the frequency f_{d} from another macro BS 1a or another femto BS 1b. The uplink signal receiving unit 11 and the transmitting unit 13 are functions required to perform essential communication with the terminal apparatuses 2 and thus are also included in each macro BS 1a, but the downlink signal receiving unit 12 is a function required for the femto BS 1b to receive (intercept) a downlink signal with the frequency f_{d} transmitted by another base station apparatus.

In addition, the RF unit 4 includes a circulator 14. The circulator 14 is to provide receive signals from the antenna 3, to the side of the uplink signal receiving unit 11 and the downlink signal receiving unit 12 and to provide a transmit signal outputted from the transmitting unit 13, to the side of the antenna 3. By the circulator 14 and a filter 135 in the transmitting unit 13, receive signals from the antenna 3 are prevented from being conveyed to the side of the transmitting unit 13.

In addition, by the circulator 14 and a filter 111 in the uplink signal receiving unit 11, a transmit signal outputted from the transmitting unit 13 is prevented from being conveyed to the uplink signal receiving unit 11. Furthermore, by the circulator 14 and a filter 121 in the downlink signal receiving unit 12, a transmit signal outputted from the transmitting unit 13 is prevented from being conveyed to the downlink signal receiving unit 12.

Here, the frequency of a downlink signal transmitted by another base station apparatus is f_{d} and is different from the frequency fᵤ of an uplink signal. Thus, a normal base station apparatus including only an uplink signal processing unit 11 cannot receive a downlink signal transmitted by another base station apparatus.

That is, in the FDD scheme, unlike the TDD scheme, since an uplink signal and a downlink signal are simultaneously present on a transmission line, the uplink signal receiving unit 11 is designed to allow only signals with the uplink signal frequency fᵤ to pass therethrough and not to allow signals with the downlink signal frequency f_{d} to pass therethrough.

The downlink signal receiving unit 12 is designed to allow only signals with the downlink signal frequency f_{d} to pass therethrough and not to allow signals with the uplink signal frequency fᵤ to pass therethrough. Then, a downlink signal from another base station apparatus which is received by the downlink signal receiving unit 12 is used in an inter-base-station synchronization process, a measurement process, etc.

The downlink signal receiving unit 12 includes the filter 121, an amplifier (high-frequency amplifier) 122, a frequency converting unit 123, a filter 124, an amplifier (intermediate-frequency amplifier) 125, a frequency converting unit 126, and an A/D converting unit 127. The filter 121 includes a band-pass filter that allows only the frequency f_{d} of a downlink signal from another base station apparatus to pass therethrough. A receive signal having passed through the filter 121 is amplified by the amplifier (high-frequency amplifier) 122, and an output from the amplifier 122 is subjected to conversion from the downlink signal frequency f_{d} to an intermediate frequency by the frequency converting unit 123. Note that the frequency converting unit 123 includes an oscillator 123a and a mixer 123b.

An output from the frequency converting unit 123 passes through the filter 124 that allows only an intermediate frequency outputted from the frequency converting unit 123 to pass therethrough, and is amplified again by the amplifier (intermediate-frequency amplifier) 125. The frequency of an output from the amplifier 125 is converted by the frequency converting unit 126 and is further converted to a digital signal by the A/D converting unit 127. Note that the frequency converting unit 126 also includes an oscillator 126a and a mixer 126b.

The signal outputted from the A/D converting unit 127 is provided to a synchronization processing unit 5b and a measurement processing unit 5c, which will be described later, included in the signal processing unit 5 (see FIG. 4).

[1.3.2 Signal Processing Unit]

In FIG. 4, the signal processing unit 5 has the function of performing signal processing of transmit and receive signals which are given and received to/from the RF unit 4, and includes a modulating/demodulating unit 5a that performs a process of modulating various transmit data to be provided by an upper layer of the signal processing unit 5 into a transmit signal and demodulating a receive signal provided by the RF unit 4 into receive data. The modulating/demodulating unit 5a performs a modulation/demodulation process with synchronization errors being corrected based on synchronization errors (timing offset and frequency offset) calculated by the synchronization processing unit 5b which will be described later.

The signal processing unit 5 further includes a frame counter 5i for determining the transmission timing for each radio frame of a transmit signal to be provided to the RF unit 4.

In addition, the signal processing unit 5 includes the synchronization processing unit 5b that performs a synchronization process in which inter-base-station synchronization is achieved with another base station apparatus; the measurement processing unit 5c that performs a measurement process in which it is determined whether resource blocks can be used in a communication area of the femto BS 1b; a resource allocation control unit 5d that allocates resource blocks; a communication condition control unit 5f that controls a communication condition used when performing wireless communication; and an allocation determining unit 5g that determines whether the resource block allocation by another base station apparatus is variable or fixed.

[1.3.2.1 For the Synchronization Processing Unit]

Inter-base-station synchronization may be performed such that each base station apparatus includes a GPS receiver and achieves synchronization by a GPS signal, or that synchronization is achieved by connecting base stations by wire; however, in the present embodiment, inter-base-station synchronization by “air synchronization” where synchronization is performed by a radio signal (downlink signal) is adopted.

Specifically, the synchronization processing unit 5b performs a synchronization process in which a downlink signal from another base station apparatus received by the downlink signal receiving unit 12 is obtained and the communication timing and communication frequency of the base station apparatus 1 are synchronized with those of another base station apparatus based on a first synchronization signal (P-SCH) and a second synchronization signal (S-SCH) which are the aforementioned known signals and are included in a radio frame of the downlink signal.

The synchronization processing unit 5b sets, on a subframe basis, the timing at which a downlink signal from another base station apparatus provided by the downlink signal receiving unit 12 is obtained, such that the above-described synchronization process is performed in a predetermined cycle (first cycle).

In addition, the synchronization processing unit 5b has the function of adjusting the timing at which a synchronization process is performed, by adjusting the cycle of the timing at which a downlink signal is obtained for a synchronization process.

The synchronization processing unit 5b starts a synchronization process with transmission of a downlink signal by the transmitting unit 13 being suspended, during a subframe section corresponding to the timing at which a downlink signal is obtained and which is set by itself (the start timing of a synchronization process). While transmission of a downlink signal is suspended, the synchronization processing unit 5b allows the downlink signal receiving unit 12 to receive a downlink signal from another base station apparatus and thereby obtains the received downlink signal. Then, using the downlink signal, the frame timing (the transmission timing of a subframe) and communication frequency of the femto BS 1b are corrected, whereby the synchronization process ends.

Note that the above-described section during which transmission of a downlink signal is suspended can be set to be subframes including a subframe corresponding to the timing at which a downlink signal from another base station apparatus is obtained for a synchronization process and one or a plurality of subframes subsequent thereto.

In addition, the synchronization processing unit 5b outputs synchronization timing information which is information for identifying subframes corresponding to a section during which transmission of a downlink signal is suspended, to the resource allocation control unit 5d and the measurement processing unit 5c.

A synchronization process will be further described. The synchronization processing unit 5b uses the aforementioned known signals (the first and the second synchronization signals) included in a downlink signal from the femto BS 1b, for a synchronization process. Specifically, the transmission timing of a subframe of a downlink signal from the femto BS 1b that includes the first and the second synchronization signals shown in FIG. 3 (the first subframe #0 or the sixth subframe #5) is grasped. Then, the synchronization processing unit 5b detects frame transmission timing of another base station apparatus and detects an error between the frame transmission timing of another base station apparatus and the frame transmission timing of the base station apparatus 1 (a frame synchronization error; a communication timing offset). Note that detection of the frame transmission timing of another base station apparatus can be performed by detecting the timings of a first synchronization signal and a second synchronization signal which are the aforementioned known signals (their waveforms are also known) and which are present in predetermined positions in a frame of a downlink signal received from another base station apparatus.

Then, when the synchronization processing unit 5b detects the above-described frame synchronization error, the synchronization processing unit 5b creates control information about frame timing for correcting the frame synchronization error and adjusts the value of the frame counter 5i in accordance with the control information and thereby corrects frame timing corresponding to the synchronization error. Though described later, to cancel the synchronization error, frame timing is corrected in the subframe #0 or #6 including the first and the second synchronization signals which are known signals.

Cancellation of the synchronization error is performed by making a correction to allow the transmission timing of the first subframe #0 or the sixth subframe #5 including the first and the second synchronization signals in a downlink signal from the femto BS 1b to match the transmission timing of a frame from another base station apparatus.

In the above-described manner, the synchronization processing unit 5b performs a synchronization process for the frame transmission timing of a downlink signal from the femto BS 1b, with another base station apparatus.

The synchronization processing unit 5b has the function of performing synchronization of frame transmission timing and also correcting carrier frequency. Hence, the synchronization processing unit 5b estimates, based on the detected synchronization error, a difference (clock frequency error) between the clock frequency of a built-in clock generator (not shown) included in the base station apparatus itself which is the receiving side and the clock frequency of a built-in clock generator of another base station apparatus which is the transmitting side, and estimates a carrier frequency error (carrier frequency offset) from the clock frequency error. Then, the synchronization processing unit 5b corrects carrier frequency based on the estimated carrier frequency error. Note that a correction to carrier frequency can be made not only to the carrier frequency of an uplink signal but also to the carrier frequency of a downlink signal.

[1.3.2.2 For the Measurement Processing Unit]

When the RF unit 4 receives a communication signal (a downlink signal in the present embodiment) between another base station apparatus and a terminal apparatus wirelessly connected to the another base station apparatus, the measurement processing unit 5c performs a measurement process in which receive power in each resource block of this receive signal is determined and it is determined, based on the receive power, whether the resource block can be used in the communication area of the femto BS 1b.

In the present embodiment, the measurement processing unit 5c sets, on a subframe basis, the timing at which a downlink signal from another base station apparatus is obtained to perform a measurement process.

Furthermore, the measurement processing unit 5c has the function of adjusting the timing at which a measurement process is performed, by adjusting the timing at which a downlink signal is obtained for a measurement process.

The measurement processing unit 5c starts a measurement process with transmission of a downlink signal by the transmitting unit 13 being suspended during a subframe section corresponding to the timing at which a downlink signal is obtained for a measurement process and which is set by itself (the start timing of a measurement process). While transmission of a downlink signal is suspended, the measurement processing unit 5c allows the downlink signal receiving unit 12 to receive a downlink signal from another base station apparatus and thereby obtains the received downlink signal. Thereafter, receive power in the resource blocks of the downlink signal is measured and the magnitude of the receive power for each resource block is compared with a threshold value, whereby the usage state of the resource block is estimated and it is determined whether the resource block can be used in the communication area of the femto BS 1b (a measurement process).

Note that the above-described section during which transmission of a downlink signal is suspended can be set to be subframes including a subframe corresponding to the timing at which obtainment of a downlink signal from another base station apparatus starts and one or a plurality of subframes subsequent thereto.

In addition, the measurement processing unit 5c outputs measurement timing information which is information for identifying subframes corresponding to the section during which transmission of a downlink signal is suspended, to the resource allocation control unit 5d.

A measurement process will be further described. A measurement process is performed after recognizing the frame timing of another base station apparatus by the above-described synchronization process. By this, since the synchronization process has been completed and since a radio frame structure of the present communication system is defined and thus the base station apparatus which is the femto BS 1b grasps the radio frame structure, the measurement processing unit 5c can extract portions determined to be resource block units from a downlink signal obtained by the downlink signal receiving unit 12, such that the portions are separated in the time-axis direction (and the frequency-axis direction). Hence, the measurement processing unit 5c can determine the extracted portions to be resource blocks.

When another base station apparatus (macro BS 1a) performs communication with a terminal apparatus 2a in its macrocell MC, data destined for the terminal apparatus 2a is allocated to the communication signal and the power in a resource block to which the data is allocated is relatively high compared with that in a resource block to which the data is not allocated. By this, without grasping the aforementioned resource allocation information, it can be determined, based on the power of the communication signal, whether a certain resource block is being used to perform communication between another base station apparatus (macro BS 1a) and the terminal apparatus 2a.

Hence, the measurement processing unit 5c determines, in the above-described manner, resource blocks from a downlink signal obtained by the downlink signal receiving unit 12 and determines an average value of receive power (power average value) for each of the determined resource blocks. Then, the measurement processing unit 5c compares the power average value with a preset threshold value. If the power average value is greater, then it can be determined that the resource block is in use. As a result, it is determined that the resource block cannot be used for the femto BS 1b (cannot be used in the communication area of the femto BS 1b).

On the other hand, if the determined power average value is smaller than the threshold value, then it can be determined that the resource block is not in use. As a result, it is determined that the resource block can be used for the femto BS 1b (can be used in the communication area of the femto BS 1b).

As such, without grasping the aforementioned resource allocation information, a measurement process can determine, based on a power average value for each resource block, whether the resource block can be used in the communication area of the femto BS 1b.

Then, the measurement processing unit 5c outputs measurement result information including information on resource blocks determined to be usable by the femto BS 1b, to the resource allocation control unit 5d and the communication condition control unit 5f.

Note that the power average value may be the average value of power in a single resource block but is preferably the average value of power in a plurality of resource blocks included in a single subframe or a plurality of consecutive subframes. This is because, as described above, a plurality of resource blocks arranged side by side in a consecutive manner in the time-axis direction are normally allocated to one same terminal apparatus, and thus the average value of power in a plurality of resource blocks can be adopted.

In the case of making a determination from a single resource block, i.e., from the power of signals obtained instantaneously, an error may occur in the determination due to an error caused by a transmit signal from a still another base station apparatus, etc. However, by thus adopting the average value of power in a plurality of resource blocks, the accuracy of determination can be increased.

[1.3.2.3 For the Resource Allocation Control Unit and the Allocation Determining Unit]

When the aforementioned measurement result information is provided to the resource allocation control unit 5d from the measurement processing unit 5c, the resource allocation control unit 5d performs, in accordance with the measurement result information, a process of allocating data to resource blocks (the aforementioned physical downlink shared channels), for communication between the base station apparatus (femto BS 1b) and a terminal apparatus 2b (see FIG. 1).

Specifically, since measurement result information includes information on resource blocks determined to be usable by the base station apparatus (femto BS 1b), the resource allocation control unit 5d having obtained the information allocates the resource blocks as areas that are used to perform communication with terminal apparatuses 2b present in the femtocell FC of the base station apparatus (femto BS 1b). Namely, the resource allocation control unit 5d functions in order to allow performing communication with terminal apparatuses 2b present in the femtocell FC, using the resource blocks determined to be usable in the femtocell FC.

In accordance with this process, resource blocks that are not used for communication between another base station apparatus (macro BS 1a) and MS 2a can be allocated as resource blocks that are used between the base station apparatus (femto BS 1b) and terminal apparatuses 2b.

Note that resource blocks that are allocated by the resource allocation control unit 5d for communication with a terminal apparatus 2b are resource blocks (physical downlink shared channels) present in later subframes in the time-axis direction than a subframe that is a target of the aforementioned measurement process.

This is because between another base station apparatus and a terminal apparatus wirelessly connected to the another base station apparatus, as described above, a plurality of resource blocks arranged side by side in a consecutive manner in the time-axis direction are allocated to one same terminal apparatus, and thus if a resource block in a subframe that is a target of a measurement process is not in use, then the same resource block present in later subframes is not in use, either.

Note also that when the aforementioned synchronization timing information and measurement timing information are provided to the resource allocation control unit 5d from the synchronization processing unit 5b and the measurement processing unit 5c, the resource allocation control unit 5d limits the allocation of data for communication of each terminal apparatus to subframes that are identified by these pieces of information.

The allocation determining unit 5g has the function of determining the degree of variations in resource block allocation performed by the macro BS 1a. The allocation determining unit 5g further has the function of changing, based on a result of the determination, a process for communicating with a terminal apparatus 2b present in the femtocell FC which is the communication area of the femto BS 1b. For example, the allocation determining unit 5g stops the above-described allocation process performed by the resource allocation control unit 5d or performs a process for reducing transmit power from the RF unit 4, in addition to the allocation process. The functions of the allocation determining unit 5g will be described later.

As described above, while the synchronization processing unit 5b starts a synchronization process in a first cycle, the measurement processing unit 5c can start determination of a communication state in a second cycle different than the first cycle. This is because once a synchronization process has been performed, then a synchronization state is considered to continue for a while, but allocation of resource blocks used between another base station apparatus and terminal apparatuses wirelessly connected to the another base station apparatus may be frequently changed. In this case, a measurement process may be performed in a second cycle shorter than the first cycle for a synchronization process.

[1.3.2.4 For the Communication Condition Control Unit]

The communication condition control unit 5f has the function of controlling a communication condition used when performing wireless communication using resource blocks allocated, by the resource allocation control unit 5d, as areas used by the base station apparatus (femto BS 1b) and a terminal apparatus 2b. For example, the communication condition control unit 5f has the function of controlling the magnitude of the transmit power of signals to be transmitted from the transmitting unit 13 in the RF unit 4, which is used when wireless communication is performed. Alternatively, for a change (control) to the communication condition, besides the control of the magnitude of transmit power, a state of a neighboring transmission line may be obtained and the modulation scheme or code rate of signals to be transmitted from the transmitting unit 13 in the RF unit 4 may be changed in accordance with the state. This change can be made on a resource-block-by-resource-block basis or on a subframe-by-subframe basis.

In addition, the communication condition control unit 5f can obtain power average values determined by the measurement processing unit 5c, estimate transmit power of the macro BS 1a from the power average values, and adjust the transmit power of the femto BS 1b based on the transmit power of the macro BS 1a. For example, when the transmit power of the femto BS 1b is relatively large with respect to the transmit power of the macro BS 1a and as a result it is determined that interference may occur, the communication condition control unit 5f can make an adjustment to reduce the transmit power of the femto BS 1b. This can limit the size of the femtocell FC.

[1.4 For a Synchronization Process]

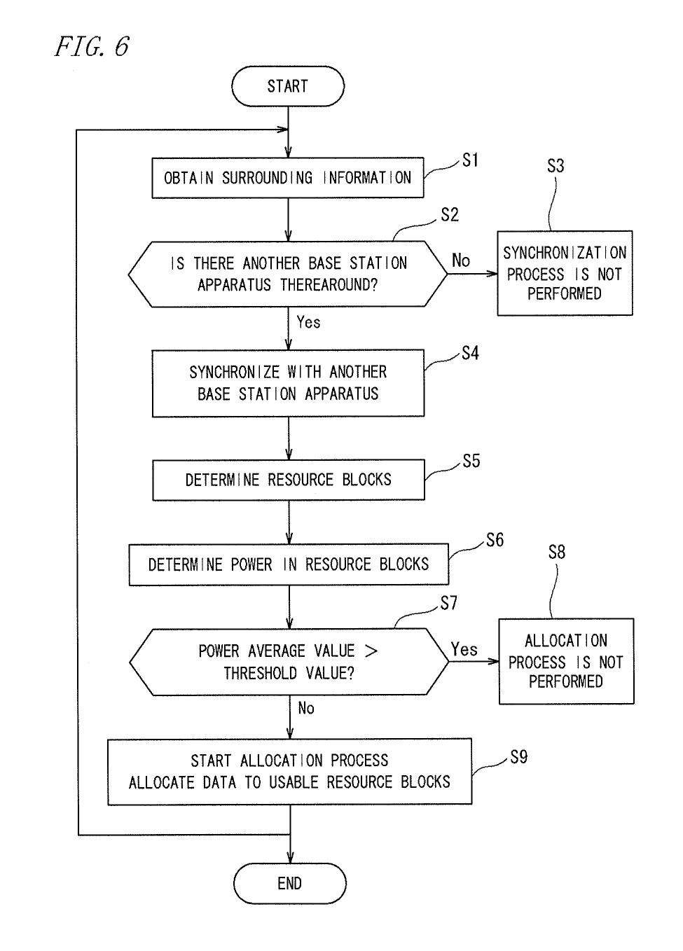

FIG. 6 is a flowchart describing a synchronization process, a measurement process, and an allocation process.

First, a femto BS 1b which is a base station apparatus (see FIG. 1) obtains signals from another base station apparatus, i.e., neighbor information (step S1), and thereby determines whether there is another base station apparatus or a terminal apparatus therearound for which a synchronization process and a measurement process need to be performed. Note that although this process is performed at startup of the femto BS 1b, this process is also periodically performed thereafter.

If there is no apparatus or terminal therearound (No in step S2), i.e., if a signal with a communicable level cannot be received, then a synchronization process is not performed (step S3).

On the other hand, if there is another base station apparatus or a terminal apparatus wirelessly connected to this base station apparatus (Yes in step S2), i.e., if a signal with a communicable level can be received, then a process for synchronizing with the another base station apparatus is performed (step S4).

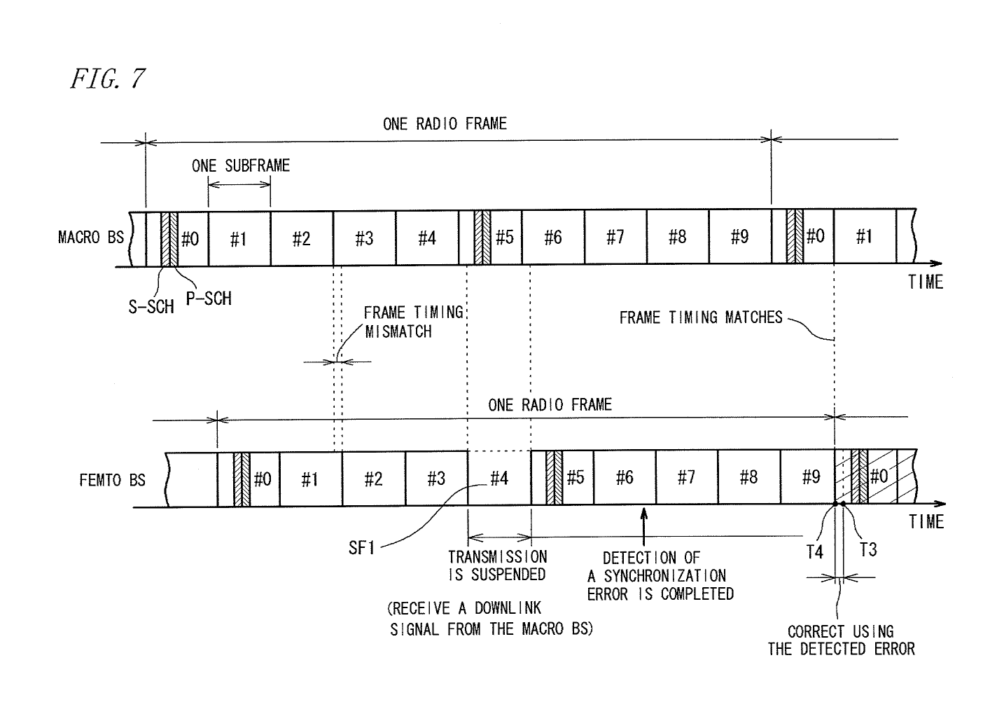

FIG. 7 is a diagram for describing an example of a mode of a synchronization process performed by the synchronization processing unit. In FIG. 7, another base station apparatus with which synchronization is achieved is a macro BS 1a. Frames that are transmitted by the macro BS 1a and a femto BS 1b which is a base station apparatus are shown on the same time axis, and a mode is shown in which the femto BS 1b performs synchronization on a downlink signal from the macro BS 1a which is a synchronization source.

FIG. 7 shows a state in which, prior to timing T4, the head of each subframe of the femto BS 1b has a timing mismatch with the head of each subframe of the macro BS 1a and thus a mismatch occurs in frame transmission timing.

In FIG. 7, the synchronization processing unit 5b of the femto BS 1b sets the timing at which a downlink signal from the macro BS 1a is obtained for a synchronization process, to a subframe SF1 corresponding to the fifth subframe #4. Then, while the synchronization processing unit 5b suspends transmission of a downlink signal by the transmitting unit 13 at the transmission timing of the subframe SF1, the synchronization processing unit 5b allows the downlink signal receiving unit 12 to receive a downlink signal from the macro BS 1a and thereby obtains the received downlink signal.

In addition, the synchronization processing unit 5b outputs synchronization timing information including information for identifying the subframe SF1, to the resource allocation control unit 5d and the measurement processing unit 5c.

Note that since the synchronization processing unit 5b can roughly grasp the transmission timing of a subframe (#0 or #5) including a first synchronization signal and a second synchronization signal in the downlink signal from the macro BS 1a, from synchronization errors having occurred in the past synchronization processes which are accumulated in a memory unit included therein, the synchronization processing unit 5b can perform setting such that a downlink signal is suspended during a subframe section of the femto BS 1b corresponding to that transmission timing.

Then, the synchronization processing unit 5b detects frame transmission timing of the macro BS 1a using a first synchronization signal and a second synchronization signal which are included in the obtained downlink signal from the macro BS 1a, and detects a frame synchronization error between the frame transmission timing of the macro BS 1a and the frame transmission timing of the femto BS 1b.

The synchronization processing unit 5b requires, after obtaining the downlink signal from the macro BS 1a, the time to determine a synchronization error based on the synchronization signals included in the downlink signal. Hence, the synchronization processing unit 5b corrects frame timing in a subframe including first and second synchronization signals that are the first ones to be arranged after obtaining the downlink signal from the macro BS 1a and determining the synchronization error.

In the case of FIG. 7, for example, assuming that, after suspending transmission by the femto BS 1b and obtaining a downlink signal from the macro BS 1a, detection of a synchronization error has been completed before a section (#6) indicated by an arrow in the drawing, the synchronization processing unit 5b waits to make a correction until a subframe #0 which is a subframe including first and second synchronization signals that are the first ones to be arranged thereafter. Then, frame timing is corrected in the subframe #0. In this case, the synchronization processing unit 5b can correct, at an early stage, frame timing in a subframe including first and second synchronization signals, with the time required to determine a synchronization error being secured.

Assuming that the head of the subframe #0 before correction is at timing T3, the synchronization processing unit 5b first adjusts the value of the frame counter 5i (FIG. 4) such that the head of the subframe #0 comes at timing T4 which is shifted by the amount of the above-described error from the timing T3. By this, the transmission timing of the subframe #0 of the downlink signal from the femto BS 1b can be allowed to match the transmission timing of a subframe #1 of the downlink signal from the macro BS 1a.

By this, the synchronization processing unit 5b can allow the frame timing of the femto BS 1b which is the base station apparatus to match the frame timing of the macro BS 1a, making it possible to achieve synchronization. In addition, although in the above only synchronization of frame timing is described, a correction to carrier frequency is also made.

[1.5 For a Measurement Process and an Allocation Process]

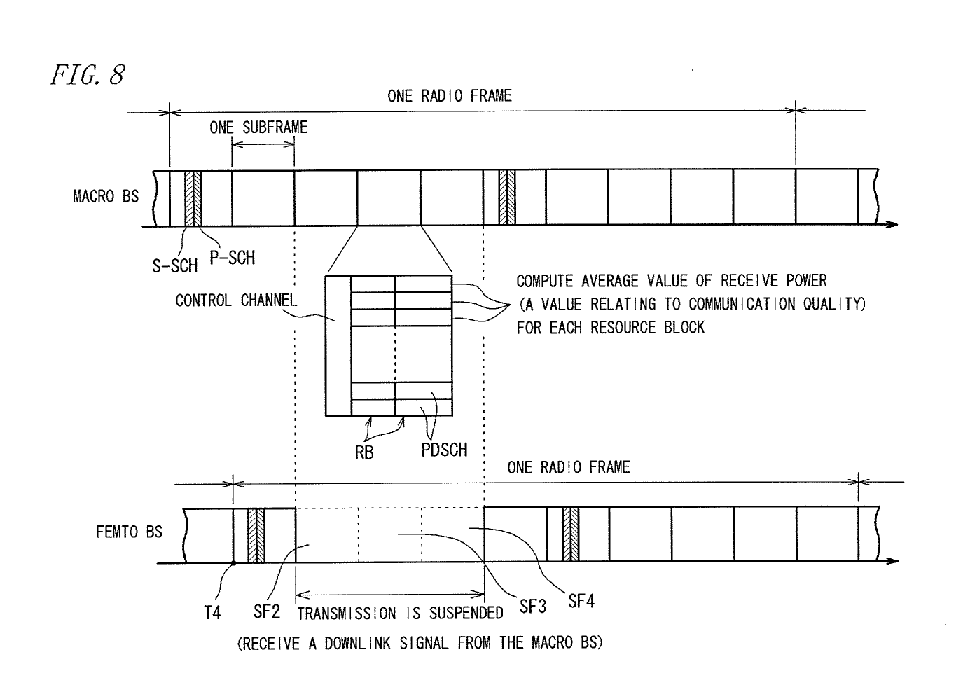

When the synchronization process in step S4 in FIG. 6 is performed, a measurement process starts. FIG. 8 is a diagram for describing an example of a mode of a measurement process performed by the measurement processing unit 5c. In FIG. 8, frames that are each transmitted by a macro BS 1a which is another base station apparatus and a femto BS 1b which is a base station apparatus are shown on the same time axis, and a mode is shown in which the femto BS 1b performs a measurement process on a downlink signal from the macro BS 1a.

The measurement processing unit 5c can identify a subframe corresponding to the start timing of a synchronization process by the synchronization processing unit 5b, by synchronization timing information provided by the synchronization processing unit 5b.

The measurement processing unit 5c performs setting to perform a measurement process in a radio frame subsequent to a radio frame to which the identified subframe corresponding to the start timing of the synchronization process belongs. That is, as shown in the drawing, a measurement process is performed in a radio frame occurring immediately after achieving synchronization at timing T4.

The measurement processing unit 5c sets the start timing of a measurement process to a subframe SF2 in the drawing. In the present embodiment, the measurement processing unit 5c sets a section during which transmission of a downlink signal is suspended for a measurement process, to be three subframes starting from the subframe corresponding to the start timing to two subsequent subframes. Thus, the measurement processing unit 5c suspends, as shown in the drawing, transmission of a downlink signal during a section of subframes SF2, SF3, and SF4. The measurement processing unit 5c outputs measurement timing information including information for identifying the subframes SF2 to SF4, to the resource allocation control unit 5d.

While the measurement processing unit 5c suspends transmission of a downlink signal by the transmitting unit 13 during the section of the subframes SF2, SF3, and SF4, the measurement processing unit 5c allows the downlink signal receiving unit 12 to receive a downlink signal transmitted from the macro BS 1a to an MS 2a and thereby obtains the received downlink signal. Then, the measurement processing unit 5c determines resource blocks from the obtained downlink signal (step S5 in FIG. 6) and determines a power average value for each resource block (step S6).

As described above, since synchronization of frame timing has been achieved between the macro BS 1a and the base station apparatus (femto BS 1b), the frame timing of the macro BS 1a can be grasped. Thus, the measurement processing unit 5c can determine resource block units in the time-axis direction with a high accuracy and can determine power average values on a resource-block-by-resource-block basis with a high accuracy.

Therefore, it is preferred that a measurement process by the measurement processing unit 5c be performed immediately after performing a synchronization process. Hence, the measurement processing unit 5c sets timing at which a measurement process is performed, in accordance with synchronization timing information provided by the synchronization processing unit 5b. Specifically, the measurement processing unit 5c identifies a subframe in which a process for a synchronization process starts, based on received synchronization timing information (see SF1 in FIG. 7) and performs a measurement process in subframes (SF2, SF3, and SF4 in FIG. 8) belonging to a radio frame subsequent to a radio frame to which the identified subframe SF1 belongs.

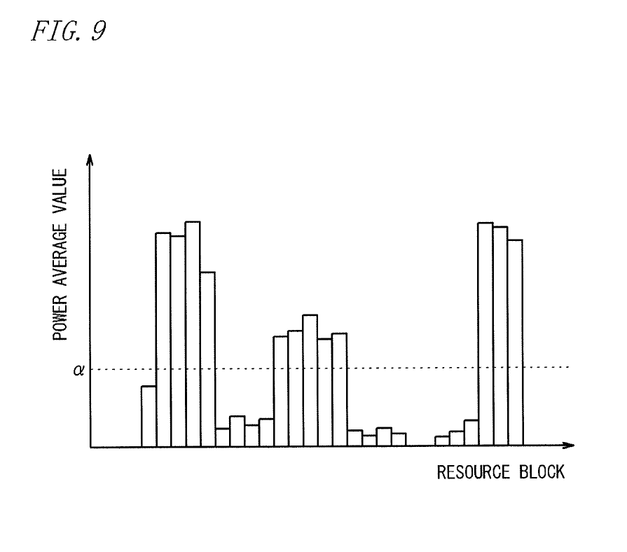

FIG. 9 is a diagram showing an example of the results of obtaining, by the measurement processing unit 5c, power average values for the respective resource blocks. In the drawing, a horizontal axis represents each resource block and a vertical axis represents a power average value.

As shown in this FIG. 9, among the resource blocks, some exhibit high power average values and some exhibit low power average values. It can be seen that in a resource block exhibiting a higher power average value which is determined by the measurement processing unit 5c than a threshold value a (Yes in step S7 in FIG. 6), data is allocated for communication between the macro BS 1a and the MS 2a, and thus, it can be estimated that the macro BS 1a is using the resource block for communication. Hence, the measurement processing unit 5c determines that this resource block cannot be used in a communication area of the base station apparatus (femto BS 1b). In this case, the resource allocation control unit 5d does not perform a resource block allocation process (step S8).

On the other hand, it can be seen that in a resource block exhibiting a lower power average value than the threshold value a (No in step S7 in FIG. 6), data for the MS 2a is not allocated, and thus, it can be estimated that the macro BS 1a is not using the resource block for communication. Hence, the measurement processing unit 5c determines that this resource block can be used in the communication area of the base station apparatus (femto BS 1b). In this case, the resource allocation control unit 5d starts an allocation process (step S9).

Specifically, in order to use, on a priority basis, resource blocks that are estimated not being used by the macro BS 1a, the resource allocation control unit 5d allocates data for communication between the base station apparatus (femto BS 1b) and an MS 2b, to the resource blocks. By this, the resource blocks used by the femto BS 1b can be avoided from overlapping the resource blocks used by the macro BS 1a and thus the occurrence of interference in the macro BS 1a and MS 2 connected to the macro BS 1a can be suppressed.

When the macro BS 1a and an MS 2a wirelessly connected to the macro BS 1a continuously perform communication, as described above, a plurality of resource blocks arranged side by side in a consecutive manner in the time-axis direction are normally allocated to one same terminal apparatus. However, resource block allocation may become variable such that due to, for example, an increase in the number of MS 2a in the macrocell MC, and the like, as a result of a resource allocation (user allocation) process by the macro BS 1a, as shown in FIG. 3, the allocation position in the frequency direction of a resource block allocated for a specific MS 2a frequently changes every subframe.

In such a variable case, even if the resource allocation control unit 5d allocates a resource block RBa which is determined by the measurement processing unit 5c to be not in use during a certain time period (a certain subframe; subframe #0 in FIG. 3), as a resource block to be used between the base station apparatus (femto BS 1b) and an MS 2b, the macro BS 1a may allocate the resource block RBa as an area for communication between the macro BS 1a and the MS 2a during later time periods (later subframes; subframes #5 and #9 in FIG. 3). In this case, interference may occur.

Hence, to suppress the occurrence of such interference, resource blocks allowed to be used by the MS 2a wirelessly connected to the macro BS 1a are allocated by the macro BS 1a on a subframe-by-subframe basis, and the allocation determining unit 5g determines whether this resource block allocation on a subframe-by-subframe basis is variable or fixed. Then, according to a result of the determination, a process for performing communication with the MS 2b present in the femtocell FC is changed.

Note that allocation being variable refers to a state where the allocation positions of resource blocks allocated to one same MS 2a are not in the same position but in different positions in the frequency direction. Namely, variable refers to the case where the degree of variations in allocation is higher than a preset threshold value.

On the other hand, allocation being fixed refers to a state where the allocation positions of resource blocks allocated to one same MS 2a are in the same position in the frequency direction. Note that the same position includes the case where the degree of being in different positions is low. That is, being fixed refers to the case where the degree of variations in allocation is lower than the preset threshold value.

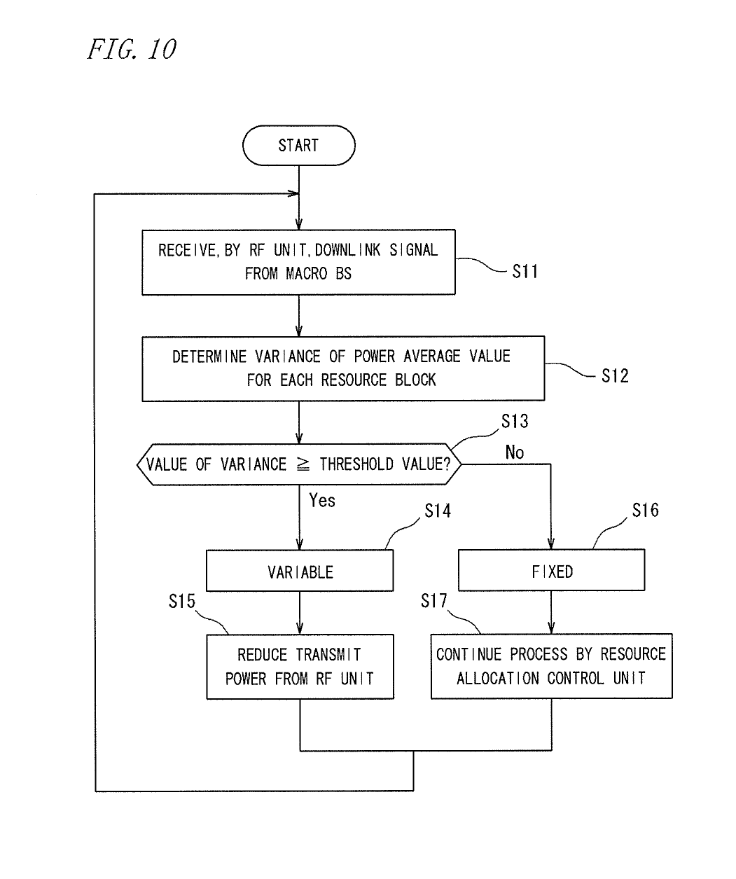

A determination process by the allocation determining unit 5g will be described. Resource blocks allowed to be used by an MS 2a wirelessly connected to the macro BS 1a are allocated by the macro BS 1a on a subframe-by-subframe basis and a downlink signal is transmitted from the macro BS 1a. As shown in FIG. 10, when the RF unit 4 of the femto BS 1b receives the downlink signal over time (step S11), the allocation determining unit 5g determines whether the allocation on a subframe-by-subframe basis is variable or fixed, based on a statistical value of a power average value for each resource block of the received downlink signal.

More specifically, the allocation determining unit 5g determines, as the statistical value, a variance of a power average value for each resource block (step S12). Then, if the value of the variance is greater than or equal to a preset threshold value (Yes in step S13), then it is considered that the power average value for the resource block has variations, i.e., it is found that resource blocks that are not used by the macro BS 1a vary from subframe to subframe, and thus, it can be determined that the resource block allocation is variable (step S14).

On the other hand, if the value of the variance is less than the threshold value (No in step S13), then it is considered that variations in power average value for the resource block are small, i.e., it is found that resource blocks that are not used by the macro BS 1a do not vary from subframe to subframe, and thus, it can be determined that the allocation is fixed (step S16).

Then, if it is determined by the allocation determining unit 5g that the allocation is fixed (step S16), then as described above, the resource allocation control unit 5d performs a process of allocating a resource block that is determined by the measurement processing unit 5c to be usable in the femtocell FC of the femto BS 1b, as an area used to communicate with an MS 2b present in the femtocell FC (step S17).

As such, when resource bock allocation by the macro BS 1a is fixed, a resource block determined to be usable is allocated as an area used to communicate with an MS 2b present in the femtocell FC and then communication can be performed with the MS 2b. Then, since the resource block determined to be usable is considered to be also usable later, interference does not occur in later resource blocks and thus the transmit power to the MS 2b does not need to be reduced, and furthermore, it is possible to avoid exerting an influence on communication between the macro BS 1a which is another base station apparatus and an MS 2a.

On the other hand, if it is determined by the allocation determining unit 5g that the allocation is variable (step S14), then the allocation determining unit 5g performs a process in which the transmit power of a signal to be transmitted from the RF unit 4 to an MS 2b present in the femtocell FC which is the communication area of the femto BS 1b is reduced to the extent that does not affect communication between the macro BS 1a and the MS 2a, and then communication is performed with the MS 2b in the femtocell FC (step S15). That is, the allocation determining unit 5g generates an instruction signal to reduce the transmit power of a signal to be transmitted from the RF unit 4, and the RF unit 4 performs a process of reducing the transmit power based on the instruction signal.

As such, when resource block allocation by the macro BS 1a is variable, resource blocks used by the femto BS 1b cannot be freely allocated based on a power average value for each resource block, but instead, resource blocks used by the femto BS 1b are arbitrarily allocated on the condition that the transmit power to an MS 2b present in the femtocell FC of the femto BS 1b is reduced to the extent that does not affect communication between the macro BS 1a and an MS 2a. By this, it is possible to avoid exerting an influence on (not to cause interference in) communication between the macro BS 1a which is another base station apparatus and the MS 2a.

In the above-described embodiment, the case is described in which the measurement processing unit 5c determines allocation of resource blocks based on a “downlink signal” which is transmitted by a macro BS 1a and received by the RF unit 4 of a base station apparatus (femto BS 1b) and determines, based on a power average value for each of the determined resource blocks, whether the resource block can be used in a communication area of the base station apparatus (femto BS 1b).

Here, it is also possible that the measurement processing unit 5c determines allocation of resource blocks based on an “uplink signal” from an MS 2a which is transmitted by the MS 2a to the macro BS 1a and received by the RF unit 4 of the base station apparatus (femto BS 1b) and determines, based on a power average value for each of the determined resource blocks, whether the resource block can be used in the communication area of the base station apparatus (femto BS 1b). This case will be described.

[1.6 For a Measurement Process in the Case of Using an Uplink Signal]

An uplink signal will be described.

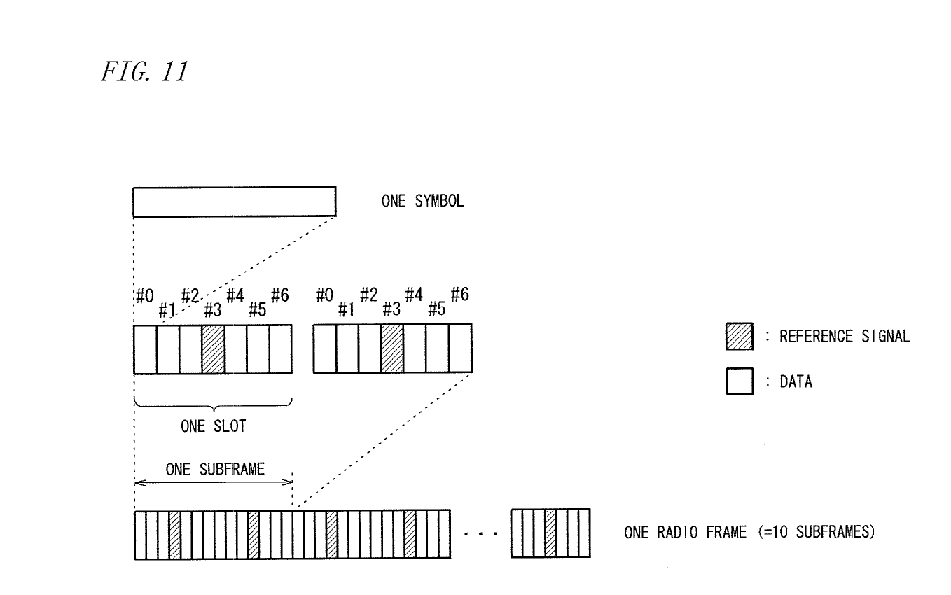

As described in FIG. 2, for radio frames on the uplink side in LTE (UL frames), each radio frame has a time length of 10 milliseconds and includes 10 subframes, #0 to #9 (each is a communication unit area having a fixed time length). FIG. 11 is a diagram showing a structure of a UL frame.

Each of the subframes forming a UL frame includes two slots. One slot includes seven OFDM symbols (#0 to #6) (in the case of Normal Cyclic Prefix).

A resource block (RB) which is a basic unit of resource allocation (the minimum unit of resource allocation) is defined as having 12 subcarriers in the frequency-axis direction and 7 OFDM symbols (#0 to #6; 1 slot) in the time-axis direction.

As a reference signal, a known signal is included in the fourth symbol (#3) in each slot (each resource block), and data of a terminal apparatus, etc., are stored in other areas (non-hatched areas in the drawing) of the resource block. Note that the femto BS 1b can also perform a synchronization process based on the uplink signal, by receiving and using the known signal included in the uplink signal.

A process in the case of using an uplink signal will be described. The configuration of a femto BS 1b for this process is the same as that in the above-described embodiment using a downlink signal (FIGS. 4 and 5). In the embodiment using the downlink signal, a measurement process is performed based on a downlink signal from another base station apparatus received by the downlink signal receiving unit 12; on the other hand, in the present embodiment using an uplink signal, a measurement process is performed based on an uplink signal from a terminal apparatus received by the uplink signal receiving unit 11. Specifically, the measurement processing unit 5c of the femto BS 1b performs a process of determining allocation of resource blocks based on an uplink signal received by the uplink signal receiving unit 11 in the RF unit 4, and determining whether the resource blocks can be used in a communication area of the femto BS 1b.

The uplink signal receiving unit 11 has the same configuration as the downlink signal receiving unit 12 (see FIG. 5), and signals outputted from an A/D converting unit 117 included in the uplink signal receiving unit 11 are provided to the measurement processing unit 5c included in the signal processing unit 5 (see FIG. 4).

Note that a synchronization process may be performed based on a downlink signal from a macro BS 1a serving as a synchronization source which is received by the downlink signal receiving unit 12, by the same method as that described in the above-described embodiment using a downlink signal. However, since each terminal apparatus 2a performs communication with a synchronization process having been performed with the macro BS 1a, a synchronization process of the femto BS 1b may be performed based on an uplink signal from a terminal apparatus 2a received by the uplink signal receiving unit 11. In this case, too, the femto BS 1b can obtain a state of being synchronized with the macro BS 1a.

Since the macro BS 1a and an MS 2 being in a state of communicating with the macro BS 1a are synchronized with each other, if the femto BS 1b performs a synchronization process with the macro BS 1a, then the femto BS 1b goes into a state of being synchronized with the MS 2. Hence, in the femto BS 1b, the measurement processing unit 5c can extract portions determined to be resource block units from an uplink signal obtained by the uplink signal receiving unit 11 such that the portions are separated in the time-axis direction (and the frequency-axis direction). Hence, by the same method as that in the embodiment using a downlink signal, the measurement processing unit 5c can determine the extracted portions to be resource blocks. Then, by determining a power average value for each resource block, it can be determined whether the resource block can be used in a communication area of the femto BS 1b, without grasping the aforementioned resource allocation information.

Although, in the embodiment using the downlink signal, the femto BS 1b needs to suspend transmission of a downlink signal upon a measurement process, in the embodiment using this uplink signal, the femto BS 1b does not need to suspend transmission of a downlink signal. This is because the frequency of a downlink signal transmitted by the RF unit 4 of the femto BS 1b differs from the frequency of an uplink signal received by the RF unit 4.

Further, receive power of uplink signals in the femto BS 1b may include power of an uplink signal from an MS 2b present in a femtocell FC of the base station apparatus (femto BS 1b) and of an uplink signal from an MS 2a present in a macrocell MC of the macro BS 1. However, the receive power of the uplink signal from the MS 2b present in the femtocell FC of the base station apparatus (femto BS 1b) can be estimated based on the transmit power of the uplink signal (a pilot signal) and the characteristics of a transmission line at that point in time. Hence, by deducting the estimated receive power from the receive power of the uplink signals in the femto BS 1b, only the power of the uplink signal from the MS 2a present in the macrocell MC of the macro BS 1a can be determined and thus a measurement process can be performed.

[1.7 Regarding Base Station Apparatuses (Femto BS 1b) According to the Embodiments]

According to base station apparatuses (femto BS 1b) according to the above-described embodiments, by the synchronization processing unit 5b performing a process for synchronizing with a macro BS 1a (another base station apparatus), resource blocks included in signals received by the RF unit 4 can be determined.

Then, the RF unit 4 receives a downlink signal (or an uplink signal) between the macro BS 1a and an MS 2a wirelessly connected to the macro BS 1a, and the measurement processing unit 5c determines, based on the received signal, a power average value of the receive signal for each resource block and can determine, based on the power average value, whether the resource block can be used in a communication area of the femto BS 1b.

If, as a result of the determination, a power average value for a certain resource block is large, then it can be estimated that the resource block is being used for communication between the macro BS 1a and the MS 2a. Thus, the femto BS 1b can refrain from communicating with an MS 2 using the resource block. Hence, the influence exerted on communication of the macro BS 1a can be suppressed.

In contrast to this, if a power average value for a certain resource block is small, then it can be estimated that the resource block is not being used for communication between the macro BS 1a and the MS 2a. Thus, in order to communicate with an MS 2b using the resource block, the femto BS 1b can allocate the resource block for its own communication. Hence, the femto BS 1b can secure its communication opportunities.

In addition, a base station apparatus (femto BS 1b) of the present invention for the case of using, for a measurement process, a downlink signal transmitted from another base station apparatus (macro BS 1a) to a terminal apparatus 2 includes a transmitting/receiving unit (RF unit 4) that can receive a downlink signal transmitted from another base station apparatus (macro BS 1a) to a terminal apparatus 2a wirelessly connected to the another base station apparatus (macro BS 1a) and that transmits a downlink signal to a terminal apparatus 2b present in a communication area of the base station apparatus (femto BS 1b); and a measurement processing unit 5c that determines power in each resource block of the downlink signal received by the transmitting/receiving unit and determines, based on the power, whether the resource block can be used in the communication area of the base station apparatus. The base station apparatus (femto BS 1b) of the present invention is characterized in that the measurement processing unit 5c determines whether resource blocks can be used in the communication area of the base station apparatus, based on the power of a downlink signal received by the transmitting/receiving unit, with transmission of a downlink signal by the transmitting/receiving unit being temporarily suspended.

According to this base station apparatus of the present invention, resource blocks usable by the base station apparatus (femto BS 1b) can be determined without obtaining the aforementioned resource allocation information included in a downlink signal from another base station apparatus (macro BS 1a).

However, at this time, downlink signals received by the transmitting/receiving unit may include a downlink signal transmitted by the base station apparatus to a terminal apparatus 2b present in the communication area of the base station apparatus (femto BS 1b), in addition to a downlink signal transmitted from another base station apparatus (macro BS 1a) to a terminal apparatus 2a. Thus, when the measurement processing unit 5c makes the above-described determination based on the power of a downlink signal, a downlink signal transmitted by the base station apparatus may become trouble.

In view of this, according to the above-described configuration of the present invention, by brining transmission of a downlink signal by the transmitting/receiving unit to a temporarily suspended state, the measurement processing unit 5c can make the above-described determination based on a downlink signal transmitted from another base station apparatus (macro BS 1a) to a terminal apparatus 2a and received by the transmitting/receiving unit, making it possible to prevent the above-described trouble.

Note that in the above-described embodiments, upon a measurement process, power in each resource block is determined; at this time, a pilot subcarrier, a data subcarrier, or both of those signals can be used.

Note also that the present invention is not limited to the above-described embodiments.

The above-described embodiments describe that in a process in which the measurement processing unit 5c determines, based on power, whether a certain resource block can be used in the communication area of the base station apparatus (femto BS 1b), a resource block with small power is not being used for communication between the macro BS 1a and an MS 2a wirelessly connected thereto. However, for a resource block with small power which is usable by the femto BS 1b, in addition to this, a resource block which is used for communication between the macro BS 1a and an MS 2a wirelessly connected thereto but whose communication signal is extremely weak and thus has small power which is determined by the measurement processing unit 5c of the femto BS 1b may also be determined to be usable in the communication area of the base station apparatus (femto BS 1b).

According to [Chapter 1] in the present invention, basic units of resource allocation usable by a base station apparatus of the present invention can be determined without obtaining resource allocation information included in a communication signal transmitted from another base station apparatus.

[Chapter 2]

[2.1 Configuration of a Communication System]

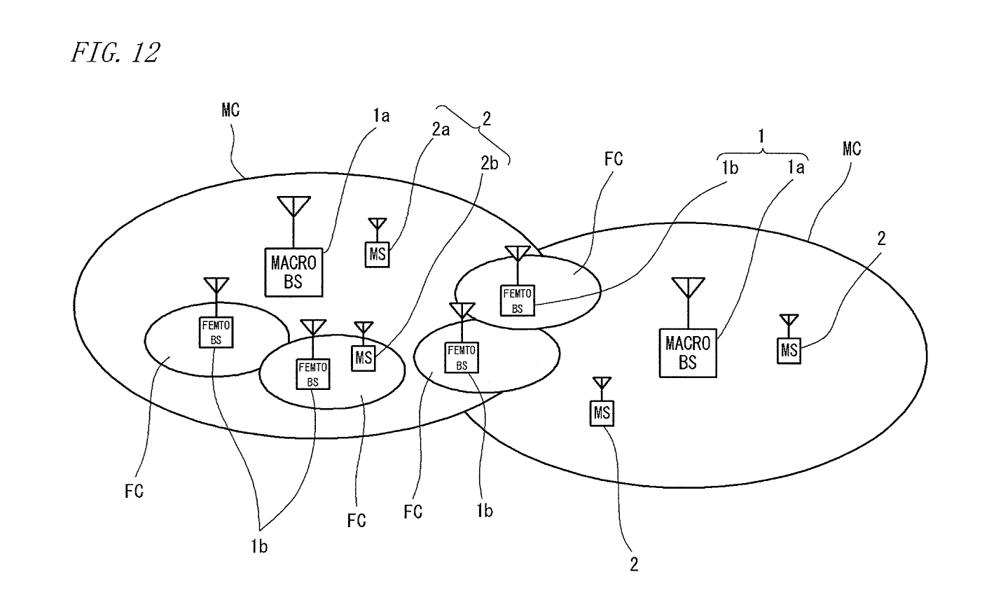

FIG. 12 is a schematic diagram showing a configuration of a wireless communication system according to Chapter 2.

The wireless communication system includes a plurality of base station apparatuses 1 and a plurality of terminal apparatuses 2 (mobile stations) that can perform wireless communication with the base station apparatuses 1.

The plurality of base station apparatuses 1 include, for example, a plurality of macro base stations 1a, each forming a communication area (macrocell) MC of several kilometers in size; and a plurality of femto base stations 1b, each installed in a macrocell MC and forming a relatively small communication area (femtocell) FC of the order of several tens of meters. The femto base stations 1b are base station apparatuses of the present invention.

Each macro base station 1a (hereinafter, also referred to as a macro BS 1a) can perform wireless communication with terminal apparatuses 2a (hereinafter, also referred to as MS 2a) present in its macrocell MC.

Each femto base station 1b (hereinafter, also referred to as a femto BS 1b) is disposed in, for example, a location where it is difficult to receive radio waves from a macro BS 1a, such as indoors, and can perform wireless communication with terminal apparatuses 2b (hereinafter, also referred to as MS 2b) present in its femtocell FC.

This system makes it possible to provide terminal apparatuses 2b with services with sufficient throughput even in a location where it is difficult to receive radio waves from a macro BS 1a, etc., by installing, in the location, a femto BS 1b which forms a relatively small femtocell FC.

In the wireless communication system, in order to prevent interference from occurring in communication between a macro BS 1a and terminal apparatuses 2 in a macrocell MC, a plurality of resource blocks into which a radio frame is divided are allocated for each terminal apparatus 2, and the terminal apparatuses 2 and the macro BS 1a perform communication in a state of being synchronized with each other, using the allocated resource blocks.

On the other hand, a femto BS 1b is installed, after installation of a macro BS 1a, in a macrocell MC formed by the macro BS 1a and forms a femtocell FC in the macrocell MC, and thus, interference, etc., may occur between terminal apparatuses 2a and 2b.

Hence, though described in detail later, each femto BS 1b has the function (monitoring function) of a measurement process in which it is determined, based on the state of communication between another base station apparatus, such as a macro BS 1a or a femto BS 1b other than itself, and terminal apparatuses 2a, i.e., the non-allocation state of resource blocks of signals used for the communication, etc., whether the resource blocks can be used in a communication area (femtocell FC) of the femto BS 1b; and the function of allocating, based on results of the determination, unallocated resource blocks for communication of the femto BS 1b so as not to affect communication in a macrocell MC, and increasing transmit power used when performing communication using the resource blocks. By these functions, the femto BS 1b can form a femtocell FC in the macrocell MC without affecting communication of another base station apparatus, and moreover secure its communication.

In addition, in the communication system of the present embodiment, inter-base-station synchronization is performed where synchronization of frame timing is achieved between a plurality of base station apparatuses including a macro BS 1a and a femto BS 1b. Inter-base-station synchronization is performed by “air synchronization” where synchronization is achieved by another base station apparatus receiving signals transmitted by a base station apparatus serving as a master (a synchronization source) to a terminal apparatus in a cell of the base station apparatus.

The base station apparatus serving as a master (a synchronization source) may achieve air synchronization with still another base station apparatus or may determine frame timing by other methods than air synchronization, such as autonomously determining frame timing by a GPS signal.

Note, however, that a macro BS 1a can have another macro BS 1a as a master but cannot have a femto BS 1b as a master. A femto BS 1b can have a macro BS 1a as a master and can also have another femto BS 1b as a master.

The wireless communication system of the present embodiment is, for example, a system for mobile phones to which LTE (Long Term Evolution) is applied, and communication complying with LTE is performed between each base station apparatus and terminal apparatuses. LTE adopts a Frequency Division Duplex (FDD) scheme. Note that the communication system is not limited in its standard to LTE and is not limited to its scheme to the FDD scheme and may adopt, for example, a TDD (Time Division Duplex) scheme.

[2.2 Frame Structure in LTE]

In the FDD scheme that can be adopted in LTE with which the communication system of the present embodiment complies, different usage frequencies are allocated to an uplink signal (also referred to as a UL signal) which is a transmit signal from a terminal apparatus 2 to a base station apparatus 1, and a downlink signal (also referred to as a DL signal) which is a transmit signal from the base station apparatus 1 to the terminal apparatus 2, whereby uplink communication and downlink communication are simultaneously performed.

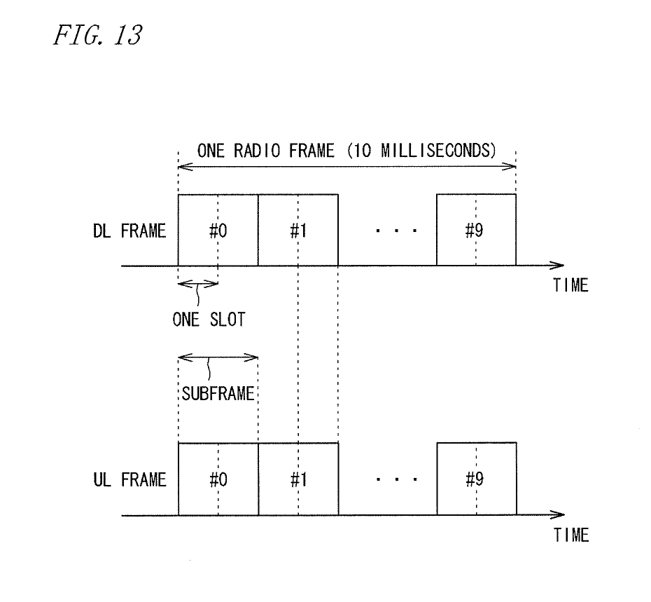

FIG. 13 is a diagram showing the structures of uplink and downlink radio frames in LTE. For a radio frame which is a basic frame on the downlink side (DL frame) in LTE and a radio frame on the uplink side (UL frame), each radio frame has a time length of 10 milliseconds and includes 10 subframes, #0 to #9 (each is a communication unit area having a fixed time length). These DL and UL frames managed by each of base station apparatuses are arranged in a time-axis direction such that their timings are aligned with each other.

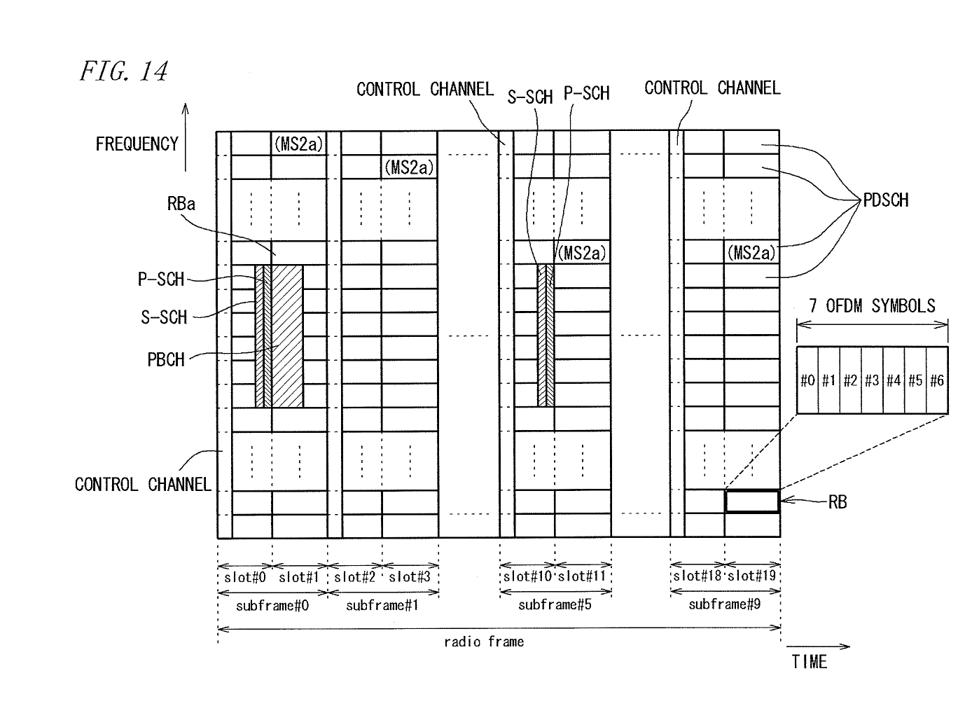

FIG. 14 is a diagram showing a detailed structure of a DL frame. In the drawing, a vertical-axis direction represents frequency and a horizontal-axis direction represents time. Each of the subframes forming a DL frame includes two slots (e.g., slots #0 and #1). One slot includes seven (#0 to #6) OFDM symbols (in the case of Normal Cyclic Prefix).

In addition, in the drawing, a resource block (RB) which is a basic unit of resource allocation (the minimum unit of resource allocation) is defined as having 12 subcarriers in the frequency-axis direction and 7 OFDM symbols (1 slot) in the time-axis direction. Therefore, for example, when the frequency bandwidth of a DL frame is set to 5 MHz, 300 subcarriers are arranged and thus 25 resource blocks are arranged in the frequency-axis direction. Resource blocks are a plurality of basic units of resource allocation into which a radio frame is divided in the time-axis direction and the frequency-axis direction on a subframe-by-subframe basis.

As shown in FIG. 14, the head of each subframe is assigned a control channel used by a base station apparatus to transmit information required for downlink communication to a terminal apparatus. A control channel is assigned using symbols #0 to #2 (three symbols at the maximum) in a slot located on the head side of each subframe. The control channel stores DL control information, resource allocation information for the subframe, etc.

In the DL frame, the first subframe #0 is assigned a Physical Broadcast Channel (PBCH) for notifying terminal apparatuses of a system bandwidth, etc., by broadcast transmission. The physical broadcast channel stores essential system information such as a communication bandwidth, the number of transmit antennas, and the structure of control information.

Of 10 subframes forming the DL frame, each of the first (#0) and sixth (#5) subframes is assigned a first synchronization signal and a second synchronization signal (P-SCH: Primary Synchronization Channel and S-SCH: Secondary Synchronization Channel) which are signals for identifying a base station apparatus and a cell.

For the first synchronization signal and the second synchronization signal, 504 types (168×3) of patterns are defined by combining them with each other. A terminal apparatus can recognize in which sector of which base station apparatus the terminal is present, by obtaining a first synchronization signal and a second synchronization signal which are transmitted from a base station apparatus.

A plurality of patterns that can be taken by the first synchronization signal and the second synchronization signal are predetermined in a communication standard and are known by each base station apparatus and each terminal apparatus. That is, the first synchronization signal and the second synchronization signal each are a known signal that can take a plurality of patterns.

As described above, a downlink signal is formed such that a plurality of subframes are arranged on a time axis, and the plurality of subframes forming the downlink signal include subframes including a first synchronization signal and a second synchronization signal and subframes not including those signals.

When the downlink signal is looked at on a subframe basis, the subframes (#0 and #5) each including a first synchronization signal and a second synchronization signal are arranged intermittently. In addition, a first synchronization signal and a second synchronization signal are arranged in the DL frame as the above-described manner and are thereby arranged cyclically in the downlink signal, with five subframes being one cycle.

The first synchronization signal and the second synchronization signal are used as signals not only for the case where a terminal apparatus achieves synchronization with a base station apparatus, but also for inter-base-station synchronization where communication timing (time) and/or frequency are/is synchronized between base station apparatuses, which will be described later.

Resource blocks in other areas where the above-described channels are not assigned (non-hatched areas in the drawing) are used as Physical Downlink Shared Channels (PDSCHs) for storing data for each terminal apparatus, etc. The physical downlink shared channels are areas shared for communication performed by a plurality of terminal apparatuses, and store control information for individual terminal apparatuses, etc., in addition to data for each terminal apparatus.

Allocation of data for terminal apparatuses to be stored in physical downlink shared channels is defined by resource allocation information in the above-described control channel assigned to the head of each subframe. A terminal apparatus grasps resource allocation information by performing various processes on a received downlink signal (with communication being established) and can thereby determine whether data destined therefor is stored in the subframe.

[2.3 Configuration of a Femto Base Station]

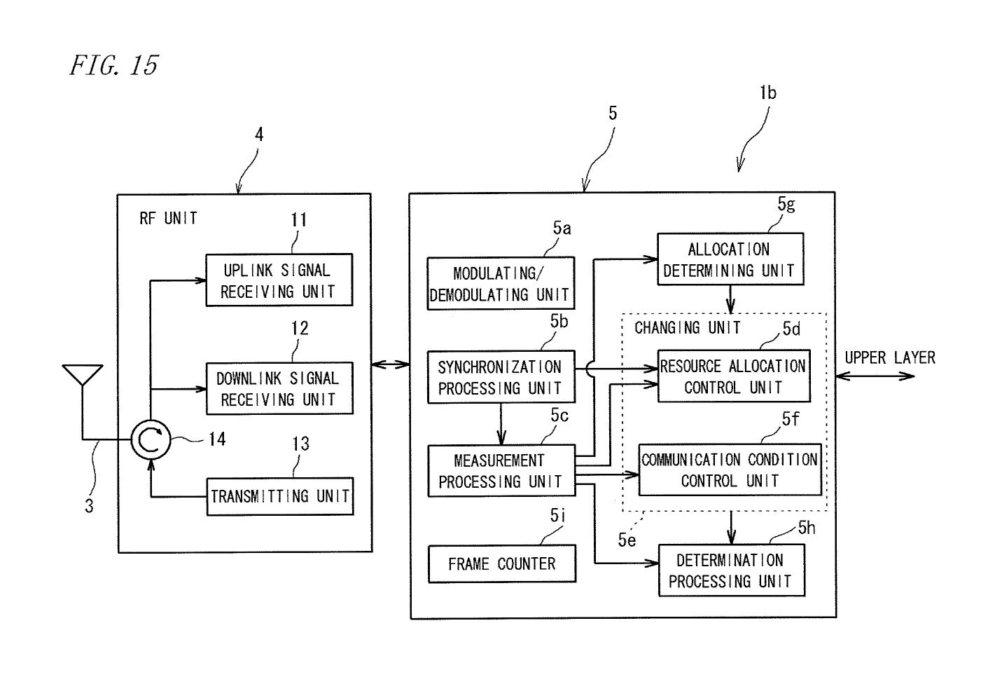

FIG. 15 is a block diagram showing a configuration of a femto BS 1b in FIG. 1. Note that here a configuration of a femto BS 1b will be described. The femto BS 1b includes an antenna 3; an RF unit (transmitting/receiving unit) 4 to which the antenna 3 is connected; and a signal processing unit 5 that performs a process for inter-base-station synchronization, a measurement process, a resource block allocation process, etc., in addition to signal processing of transmit and receive signals which are given and received to/from the RF unit 4. Note that the configuration of a macro BS 1a is substantially the same as that of the femto BS 1b in terms of the above points.

[2.3.1 RF Unit]

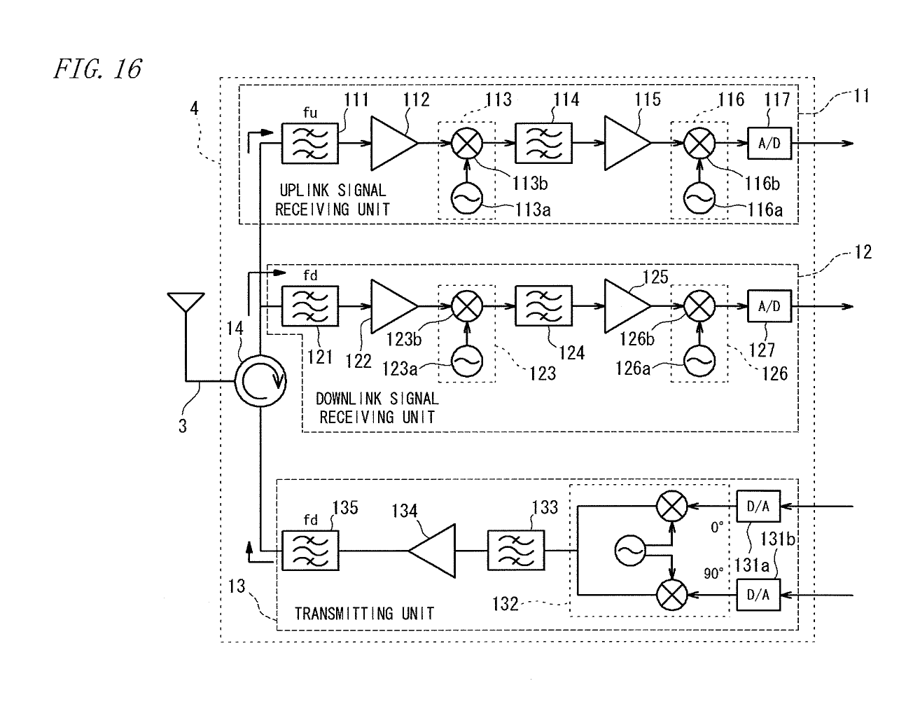

FIG. 16 is a block diagram showing a detail of the RF unit 4. The RF unit 4 includes an uplink signal receiving unit 11, a downlink signal receiving unit 12, and a transmitting unit 13. The uplink signal receiving unit 11 is to receive uplink signals with a frequency fᵤ from terminal apparatuses 2, and the transmitting unit 13 is to transmit downlink signals with a frequency f_{d} to the terminal apparatuses 2. The downlink signal receiving unit 12 is to receive a downlink signal with the frequency f_{d} from another macro BS 1a or another femto BS 1b. The uplink signal receiving unit 11 and the transmitting unit 13 are functions required to perform essential communication with the terminal apparatuses 2 and thus are also included in each macro BS 1a, but the downlink signal receiving unit 12 is a function required for the femto BS 1b to receive (intercept) a downlink signal with the frequency f_{d} transmitted by another base station apparatus.

In addition, the RF unit 4 includes a circulator 14. The circulator 14 is to provide receive signals from the antenna 3, to the sides of the uplink signal receiving unit 11 and the downlink signal receiving unit 12 and to provide a transmit signal outputted from the transmitting unit 13, to the side of the antenna 3. By the circulator 14 and a filter 135 in the transmitting unit 13, receive signals from the antenna 3 are prevented from being conveyed to the side of the transmitting unit 13.

In addition, by the circulator 14 and a filter 111 in the uplink signal receiving unit 11, a transmit signal outputted from the transmitting unit 13 is prevented from being conveyed to the uplink signal receiving unit 11. Furthermore, by the circulator 14 and a filter 121 in the downlink signal receiving unit 12, a transmit signal outputted from the transmitting unit 13 is prevented from being conveyed to the downlink signal receiving unit 12.

Here, the frequency of a downlink signal transmitted by another base station apparatus is f_{d} and is different from the frequency fᵤ of an uplink signal. Thus, a normal base station apparatus including only an uplink signal processing unit 11 cannot receive a downlink signal transmitted by another base station apparatus.

That is, in the FDD scheme, unlike the TDD scheme, since an uplink signal and a downlink signal are simultaneously present on a transmission line, the uplink signal receiving unit 11 is designed to allow only signals with the uplink signal frequency fᵤ to pass therethrough and not to allow signals with the downlink signal frequency f_{d} to pass therethrough.

The downlink signal receiving unit 12 is designed to allow only signals with the downlink signal frequency f_{d} to pass therethrough and not to allow signals with the uplink signal frequency fᵤ to pass therethrough. Then, a downlink signal from another base station apparatus which is received by the downlink signal receiving unit 12 is used in an inter-base-station synchronization process, a measurement process, etc.

The downlink signal receiving unit 12 includes the filter 121, an amplifier (high-frequency amplifier) 122, a frequency converting unit 123, a filter 124, an amplifier (intermediate-frequency amplifier) 125, a frequency converting unit 126, and an A/D converting unit 127. The filter 121 includes a band-pass filter that allows only the frequency f_{d} of a downlink signal from another base station apparatus to pass therethrough. A receive signal having passed through the filter 121 is amplified by the amplifier (high-frequency amplifier) 122, and an output from the amplifier 122 is subjected to conversion from the downlink signal frequency f_{d} to an intermediate frequency by the frequency converting unit 123. Note that the frequency converting unit 123 includes an oscillator 123a and a mixer 123b.

An output from the frequency converting unit 123 passes through the filter 124 that allows only an intermediate frequency outputted from the frequency converting unit 123 to pass therethrough, and is amplified again by the amplifier (intermediate-frequency amplifier) 125. The frequency of an output from the amplifier 125 is converted by the frequency converting unit 126 and is further converted to a digital signal by the A/D converting unit 127. Note that the frequency converting unit 126 also includes an oscillator 126a and a mixer 126b.

The signal outputted from the A/D converting unit 127 is provided to a synchronization processing unit 5b and a measurement processing unit 5c, which will be described later, included in the signal processing unit 5 (see FIG. 15).

[2.3.2 Signal Processing Unit]

In FIG. 15, the signal processing unit 5 has the function of performing signal processing of transmit and receive signals which are given and received to/from the RF unit 4, and includes a modulating/demodulating unit 5a that performs a process of modulating various transmit data to be provided by an upper layer of the signal processing unit 5 into a transmit signal and demodulating a receive signal provided by the RF unit 4 into receive data. The modulating/demodulating unit 5a performs a modulation/demodulation process with synchronization errors being corrected based on synchronization errors (timing offset and frequency offset) calculated by the synchronization processing unit 5b which will be described later.

The signal processing unit 5 further includes a frame counter 5i for determining the transmission timing for each radio frame of a transmit signal to be provided to the RF unit 4.

In addition, the signal processing unit 5 includes the synchronization processing unit 5b that performs a synchronization process in which inter-base-station synchronization is achieved with another base station apparatus; the measurement processing unit 5c that performs a measurement process in which it is determined whether resource blocks can be used in a communication area of the femto BS 1b; a changing unit 5e that can change the way to use a resource block based on a result of the determination by the measurement processing unit 5c in order to communicate with a terminal apparatus 2b present in the communication area of the femto BS 1b; a determination processing unit 5h that determines whether the change to the way to use made by the changing unit 5e is appropriate; and an allocation determining unit 5g that determines whether resource block allocation by another base station apparatus is variable or fixed.

[2.3.2.1 For the Synchronization Processing Unit]

Inter-base-station synchronization may be performed such that each base station apparatus includes a GPS receiver and achieves synchronization by a GPS signal, or that synchronization is achieved by connecting base stations by wire; however, in the present embodiment, inter-base-station synchronization by “air synchronization” where synchronization is performed by a radio signal (downlink signal) is adopted.

Specifically, the synchronization processing unit 5b performs a synchronization process in which a downlink signal from another base station apparatus received by the downlink signal receiving unit 12 is obtained and the communication timing and communication frequency of the base station apparatus 1 are synchronized with those of another base station apparatus based on a first synchronization signal (P-SCH) and a second synchronization signal (S-SCH) which are the aforementioned known signals and are included in a radio frame of the downlink signal.

The synchronization processing unit 5b sets, on a subframe basis, the timing at which a downlink signal from another base station apparatus provided by the downlink signal receiving unit 12 is obtained, such that the above-described synchronization process is performed in a predetermined cycle (first cycle).

In addition, the synchronization processing unit 5b has the function of adjusting the timing at which a synchronization process is performed, by adjusting the cycle of the timing at which a downlink signal is obtained for a synchronization process.

The synchronization processing unit 5b starts a synchronization process with transmission of a downlink signal by the transmitting unit 13 being suspended, during a subframe section corresponding to the timing at which a downlink signal is obtained and which is set by itself (the start timing of a synchronization process). While transmission of a downlink signal is suspended, the synchronization processing unit 5b allows the downlink signal receiving unit 12 to receive a downlink signal from another base station apparatus and thereby obtains the received downlink signal. Then, using the downlink signal, the frame timing (the transmission timing of a subframe) and communication frequency of the femto BS 1b are corrected, whereby the synchronization process ends.

Note that the above-described section during which transmission of a downlink signal is suspended can be set to be subframes including a subframe corresponding to the timing at which a downlink signal from another base station apparatus is obtained for a synchronization process and one or a plurality of subframes subsequent thereto.

In addition, the synchronization processing unit 5b outputs synchronization timing information which is information for identifying subframes corresponding to a section during which transmission of a downlink signal is suspended, to a resource allocation control unit 5d and the measurement processing unit 5c.

A synchronization process will be further described. The synchronization processing unit 5b uses the aforementioned known signals (first and second synchronization signals) included in a downlink signal from the femto BS 1b, for a synchronization process. Specifically, the transmission timing of a subframe of a downlink signal from the femto BS 1b that includes first and second synchronization signals shown in FIG. 14 (the first subframe #0 or the sixth subframe #5) is grasped. Then, the synchronization processing unit 5b detects frame transmission timing of another base station apparatus and detects an error between the frame transmission timing of another base station apparatus and the frame transmission timing of the base station apparatus 1 (a frame synchronization error; a communication timing offset). Note that detection of the frame transmission timing of another base station apparatus can be performed by detecting the timings of a first synchronization signal and a second synchronization signal which are the aforementioned known signals (their waveforms are also known) and which are present in predetermined positions in a frame of a downlink signal received from another base station apparatus.

Then, when the synchronization processing unit 5b detects the above-described frame synchronization error, the synchronization processing unit 5b creates control information on frame timing for correcting the frame synchronization error and adjusts the value of the frame counter 5i according to the control information and thereby corrects frame timing in accordance with the synchronization error. Though described later, to cancel the synchronization error, frame timing is corrected in the subframe #0 or #6 including first and second synchronization signals which are known signals.

Cancellation of the synchronization error is performed by making a correction to allow the transmission timing of the first subframe #0 or the sixth subframe #5 including first and second synchronization signals in a downlink signal from the femto BS 1b to match the transmission timing of a frame from another base station apparatus.

In the above-described manner, the synchronization processing unit 5b performs a synchronization process for the frame transmission timing of a downlink signal from the femto BS 1b, with another base station apparatus.

The synchronization processing unit 5b has the function of performing synchronization of frame transmission timing and also correcting carrier frequency. Hence, the synchronization processing unit 5b estimates, based on the detected synchronization error, a difference (clock frequency error) between the clock frequency of a built-in clock generator (not shown) included in the base station apparatus itself which is the receiving side and the clock frequency of a built-in clock generator of another base station apparatus which is the transmitting side, and estimates a carrier frequency error (carrier frequency offset) from the clock frequency error. Then, the synchronization processing unit 5b corrects carrier frequency based on the estimated carrier frequency error. Note that a correction to carrier frequency can be made not only to the carrier frequency of an uplink signal but also to the carrier frequency of a downlink signal.

[2.3.2.2 For the Measurement Processing Unit]

When the RF unit 4 receives a communication signal (a downlink signal in the present embodiment) between another base station apparatus and a terminal apparatus wirelessly connected to the another base station apparatus, the measurement processing unit 5c performs a measurement process in which receive power in each resource block of this receive signal is determined and it is determined, based on the receive power, whether the resource block can be used in the communication area of the femto BS 1b.

In the present embodiment, the measurement processing unit 5c sets, on a subframe basis, the timing at which a downlink signal from another base station apparatus is obtained to perform a measurement process.

Furthermore, the measurement processing unit 5c has the function of adjusting the timing at which a measurement process is performed, by adjusting the timing at which a downlink signal is obtained for a measurement process.

The measurement processing unit 5c starts a measurement process with transmission of a downlink signal by the transmitting unit 13 being suspended during a subframe section corresponding to the timing at which a downlink signal is obtained for a measurement process and which is set by itself (the start timing of a measurement process). While transmission of a downlink signal is suspended, the measurement processing unit 5c allows the downlink signal receiving unit 12 to receive a downlink signal from another base station apparatus and thereby obtains the received downlink signal. Thereafter, receive power in the resource blocks of the downlink signal is measured and the magnitude of the receive power for each resource block is compared with a threshold value, whereby the usage state of the resource block is estimated and it is determined whether the resource block can be used in the communication area of the femto BS 1b (a measurement process).

Note that the above-described section during which transmission of a downlink signal is suspended can be set to be subframes including a subframe corresponding to the timing at which obtainment of a downlink signal from another base station apparatus starts and one or a plurality of subframes subsequent thereto.

In addition, the measurement processing unit 5c outputs measurement timing information which is information for identifying subframes corresponding to the section during which transmission of a downlink signal is suspended, to the resource allocation control unit 5d.

A measurement process will be further described. A measurement process is performed after recognizing the frame timing of another base station apparatus by the above-described synchronization process. By this, since the synchronization process has been completed and since a radio frame structure of the present communication system is defined and thus the base station apparatus which is the femto BS 1b grasps the radio frame structure, the measurement processing unit 5c can extract portions determined to be resource block units from a downlink signal obtained by the downlink signal receiving unit 12, such that the portions are separated in the time-axis direction (and the frequency-axis direction). Hence, the measurement processing unit 5c can determine the extracted portions to be resource blocks.

When another base station apparatus (macro BS 1a) performs communication with a terminal apparatus 2a in its macrocell MC, data destined for the terminal apparatus 2a is allocated to the communication signal and the power in a resource block to which the data is allocated is relatively high compared with that in a resource block to which the data is not allocated. By this, without grasping the aforementioned resource allocation information, it can be determined, based on the power of the communication signal, whether a certain resource block is being used to perform communication between another base station apparatus (the macro BS 1a) and the terminal apparatus 2a.

Hence, the measurement processing unit 5c determines, in the above-described manner, resource blocks from a downlink signal obtained by the downlink signal receiving unit 12 and determines an average value of receive power (power average value) for each of the determined resource blocks. Then, the measurement processing unit 5c compares the power average value with a preset threshold value. If the power average value is greater, then it can be determined that the resource block is in use. As a result, it is determined that the resource block cannot be used for the femto BS 1b (cannot be used in the communication area of the femto BS 1b).

On the other hand, if the determined power average value is smaller than the threshold value, then it can be determined that the resource block is not in use. As a result, it is determined that the resource block can be used for the femto BS 1b (can be used in the communication area of the femto BS 1b).

As such, without grasping the aforementioned resource allocation information, a measurement process can determine, based on a power average value for each resource block, whether the resource block can be used in the communication area of the femto BS 1b.

Then, the measurement processing unit 5c outputs measurement result information including information on resource blocks determined to be usable by the femto BS 1b, to the resource allocation control unit 5d and a communication condition control unit 5f.

Note that the power average value may be the average value of power in a single resource block but is preferably the average value of power in a plurality of resource blocks included in a single subframe or a plurality of consecutive subframes. This is because, as described above, a plurality of resource blocks arranged side by side in a consecutive manner in the time-axis direction are normally allocated to one same terminal apparatus, and thus the average value of power in a plurality of resource blocks can be adopted.

In the case of making a determination from a single resource block, i.e., from the power of a signal obtained instantaneously, an error may occur in the determination due to an error caused by a transmit signal from a still another base station apparatus, etc. However, by thus adopting the average value of power in a plurality of resource blocks, the accuracy of determination can be increased.

[2.3.2.3 For the Changing Unit]

In FIG. 15, the changing unit 5e has the function of changing the way to use a resource block (a communication parameter relating to the way to use a resource block) in order to communicate with a terminal apparatus 2b present in the communication area of the femto BS 1b, and includes the resource allocation control unit 5d having a resource allocation function that performs resource block allocation; and the communication condition control unit 5f having a communication condition control function that controls a communication condition, such as transmit power, used when performing wireless communication.

That is, the changing unit 5e changes the way to use a resource block based on a result of determination by the measurement processing unit 5c, in order to communicate with a terminal apparatus 2b present in the communication area of the femto BS 1b. The change to the way to use a resource block is one or both of the following: a process of allocating a usable resource block as an area used by the femto BS 1b and a process of changing transmit power in a resource block used by the femto BS 1b.

[2.3.2.3.1 For the Resource Allocation Control Unit and the Allocation Determining Unit]

When the aforementioned measurement result information is provided to the resource allocation control unit 5d from the measurement processing unit 5c, the resource allocation control unit 5d performs, in accordance with the measurement result information, a process of allocating data to resource blocks (the aforementioned physical downlink shared channels), for communication between the base station apparatus (femto BS 1b) and a terminal apparatus 2b (see FIG. 12).

Specifically, since the measurement result information includes information on resource blocks determined to be usable by the base station apparatus (femto BS 1b), the resource allocation control unit 5d having obtained the information allocates the resource blocks as areas that are used to perform communication with terminal apparatuses 2b present in the femtocell FC of the base station apparatus (femto BS 1b). Namely, the resource allocation control unit 5d functions in order to allow performing communication with terminal apparatuses 2b present in the femtocell FC, using the resource blocks determined to be usable in the femtocell FC. According to this process, resource blocks that are not used for communication between another base station apparatus (macro BS 1a) and MS 2a can be allocated as resource blocks that are used between the base station apparatus (femto BS 1b) and terminal apparatuses 2b.

Note that resource blocks that are allocated by the resource allocation control unit 5d for communication with a terminal apparatus 2b are resource blocks (physical downlink shared channels) present in later subframes in the time-axis direction than a subframe that is a target of the aforementioned measurement process.

This is because between another base station apparatus and a terminal apparatus wirelessly connected to the another base station apparatus, as described above, a plurality of resource blocks arranged side by side in a consecutive manner in the time-axis direction are allocated to one same terminal apparatus, and thus if a resource block in a subframe that is a target of a measurement process is not in use, then the same resource block present in later subframes is not in use, either.

Note also that when the aforementioned synchronization timing information and the measurement timing information are provided to the resource allocation control unit 5d from the synchronization processing unit 5b and the measurement processing unit 5c, the resource allocation control unit 5d limits the allocation of data for communication of each terminal apparatus to subframes that are identified by these pieces of information.

The allocation determining unit 5g has the function of determining the degree of variations in resource block allocation performed by the macro BS 1a. The allocation determining unit 5g further has the function of changing, based on a result of the determination, a process for communicating with a terminal apparatus 2b present in the femtocell FC which is the communication area of the femto BS 1b. For example, the allocation determining unit 5g stops the above-described allocation process performed by the resource allocation control unit 5d or performs a process for reducing transmit power from the RF unit 4, in addition to the allocation process. The functions of the allocation determining unit 5g will be described later.

As described above, while the synchronization processing unit 5b starts a synchronization process in a first cycle, the measurement processing unit 5c can start determination of a communication state in a second cycle different than the first cycle. This is because once a synchronization process has been performed, then a synchronization state is considered to continue for a while, but allocation of resource blocks used between another base station apparatus and terminal apparatuses wirelessly connected to the another base station apparatus may be frequently changed. In this case, a measurement process may be performed in a second cycle shorter than the first cycle for a synchronization process.

[2.3.2.3.2 For the Communication Condition Control Unit]

Since measurement result information created by the measurement processing unit 5c includes information on resource blocks determined to be usable by the base station apparatus (femto BS 1b), the communication condition control unit 5f having obtained the information has the function of controlling a communication condition used when performing wireless communication using the resource blocks. For example, the communication condition control unit 5f has the function of increasing, in the resource blocks, the transmit power of signals to be transmitted from the RF unit 4 to a terminal apparatus 2b present in the femtocell FC.

Since it is considered that resource blocks determined to be usable by the base station apparatus (femto BS 1b) are not being used by another base station apparatus, even if communication is performed with a terminal apparatus 2b present in the communication area of the base station apparatus by increasing transmit power in the resource blocks, the influence exerted on communication of another base station apparatus can be suppressed.

Furthermore, for a change (control) to the communication condition, besides the control of the magnitude of transmit power, the communication condition control unit 5f may obtain a state of a neighboring transmission line and change, in accordance with the state, the modulation scheme or code rate of signals to be transmitted from the transmitting unit in the RF unit 4. This change can be made on a resource-block-by-resource-block basis or on a subframe-by-subframe basis.

In addition, the communication condition control unit 5f can obtain power average values determined by the measurement processing unit 5c, estimate transmit power of the macro BS 1a from the power average values, and adjust the transmit power of the femto BS 1b based on the transmit power of the macro BS 1a. For example, when the transmit power of the femto BS 1b is relatively large with respect to the transmit power of the macro BS 1a and as a result it is determined that interference may occur, the communication condition control unit 5f can make an adjustment to reduce the transmit power of the femto BS 1b. This can limit the size of the femtocell FC.

[2.3.2.4 For the Determination Processing Unit]

The determination processing unit 5h has the function of determining whether a change to the way to use a resource block made by the changing unit 5e is appropriate. Note that the change to the way to use a resource block is, as described above, one or both of the following: a process of allocating a usable resource block as an area used by the femto BS 1b and a process of changing transmit power in a resource block used by the femto BS 1b.

Further, a determination as to whether a change to the way to use a resource block is appropriate is made based on a difference between power average values in a resource block which are determined by the measurement processing unit 5c before and after the change to the way to use a resource block.

To allow the determination processing unit 5h to function in the above-described manner, the above-described power average values before and after the change to the way to use a resource block made by the changing unit 5e are determined by the measurement processing unit 5c. The determination processing unit 5h determines a difference (the absolute value of a difference) between a power average value V1 determined by the measurement processing unit 5c before the change to the way to use a resource block and a power average value V2 determined after the change to the way to use a resource block. In the determination processing unit 5h, a threshold value Vβ for the difference between the power average values is set.

If the absolute value of the difference (V1−V2) between the power average values before and after the change to the way to use a resource block exceeds the threshold value Vβ, then the determination processing unit 5h determines that the change to the way to use a resource block is inappropriate, and thus, performs a process of invalidating the change to the way to use. The process of invalidating the change is a process of allowing the changing unit 5e to perform a process of bringing the state back to the one obtained before the change, by an instruction signal from the determination processing unit 5h.

On the other hand, if the absolute value of the difference (V1−V2) between the power average values before and after the change to the way to use a resource block is less than or equal to the threshold value Vβ, then the determination processing unit 5h determines that the change to the way to use a resource block is appropriate, and thus, performs a process of validating the change to the way to use a resource block. The process of validating the change is a process of maintaining the state obtained after the change, and the RF unit 4 communicates with a terminal apparatus 2b present in the communication area of the femto BS 1b, by the changed way to use a resource block.

[2.4 For a Synchronization Process]

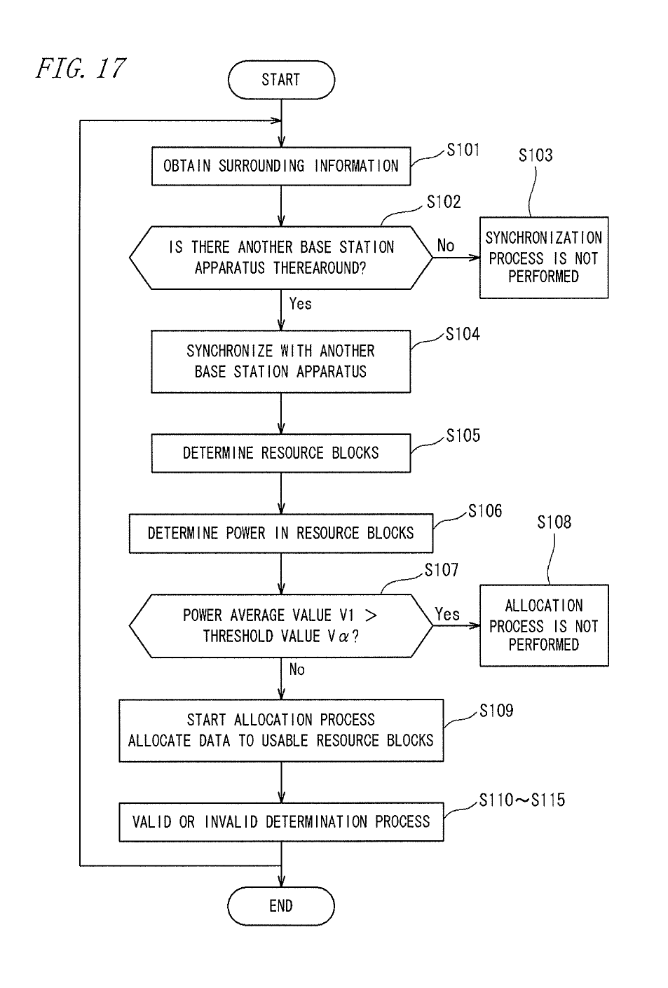

FIG. 17 is a flowchart describing a synchronization process, a measurement process, and a process of changing the way to use a resource block.

First, a femto BS 1b which is a base station apparatus (see FIG. 12) obtains signals from another base station apparatus, i.e., neighbor information (step S101), and thereby determines whether there is another base station apparatus or a terminal apparatus therearound for which a synchronization process and a measurement process need to be performed. Note that although this process is performed at startup of the femto BS 1b, this process is also periodically performed thereafter.

If there is no apparatus or terminal therearound (No in step S102), i.e., if a signal with a communicable level cannot be received, then a synchronization process is not performed (step S103).

On the other hand, if there is another base station apparatus or a terminal apparatus wirelessly connected to this base station apparatus (Yes in step S102), i.e., if a signal with a communicable level can be received, then a process for synchronizing with the another base station apparatus is performed (step S104).

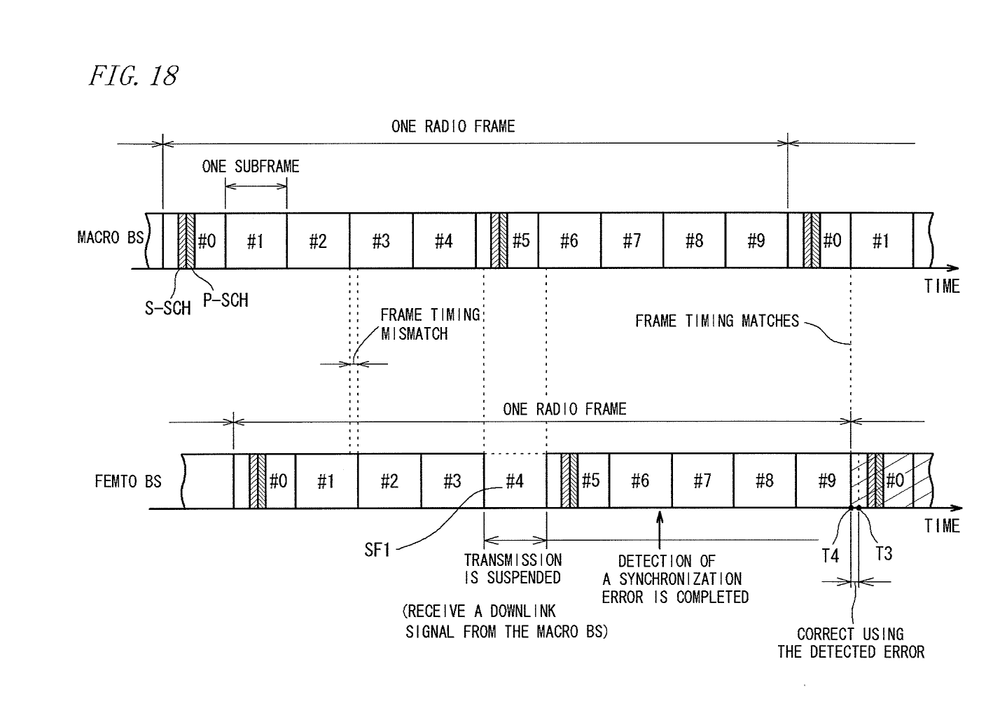

FIG. 18 is a diagram for describing an example of a mode of a synchronization process performed by the synchronization processing unit. In FIG. 18, another base station apparatus with which synchronization is achieved is a macro BS 1a. Frames that are transmitted by the macro BS la and a femto BS 1b which is a base station apparatus are shown on the same time axis, and a mode is shown in which the femto BS 1b performs synchronization on a downlink signal from the macro BS 1a which is a synchronization source.

FIG. 18 shows a state in which, prior to timing T4, the head of each subframe of the femto BS 1b has a timing mismatch with the head of each subframe of the macro BS 1a and thus a mismatch occurs in frame transmission timing.

In FIG. 18, the synchronization processing unit 5b of the femto BS 1b sets the timing at which a downlink signal from the macro BS 1a is obtained for a synchronization process, to a subframe SF1 corresponding to the fifth subframe #4. Then, while the synchronization processing unit 5b suspends transmission of a downlink signal by the transmitting unit 13 at the transmission timing of the subframe SF1, the synchronization processing unit 5b allows the downlink signal receiving unit 12 to receive a downlink signal from the macro BS 1a and thereby obtains the received downlink signal.

In addition, the synchronization processing unit 5b outputs synchronization timing information including information for identifying the subframe SF1, to the resource allocation control unit 5d and the measurement processing unit 5c.

Note that since the synchronization processing unit 5b can roughly grasp the transmission timing of a subframe (#0 or #5) including a first synchronization signal and a second synchronization signal in the downlink signal from the macro BS 1a, from synchronization errors having occurred in the past synchronization processes which are accumulated in a memory unit included therein, the synchronization processing unit 5b can perform setting such that a downlink signal is suspended during a subframe section of the femto BS 1b corresponding to that transmission timing.

Then, the synchronization processing unit 5b detects frame transmission timing of the macro BS 1a using a first synchronization signal and a second synchronization signal which are included in the obtained downlink signal from the macro BS 1a, and detects a frame synchronization error between the frame transmission timing of the macro BS 1a and the frame transmission timing of the femto BS 1b.

The synchronization processing unit 5b requires, after obtaining the downlink signal from the macro BS 1a, the time to determine a synchronization error based on the synchronization signals included in the downlink signal. Hence, the synchronization processing unit 5b corrects frame timing in a subframe including first and second synchronization signals that are the first ones to be arranged after obtaining the downlink signal from the macro BS 1a and determining the synchronization error.

In the case of FIG. 18, for example, assuming that, after suspending transmission by the femto BS 1b and obtaining a downlink signal from the macro BS 1a, detection of a synchronization error has been completed before a section (#6) indicated by an arrow in the drawing, the synchronization processing unit a waits to make a correction until a subframe #0 which is a subframe including first and second synchronization signals that are the first ones to be arranged thereafter. Then, frame timing is corrected in the subframe #0. In this case, the synchronization processing unit 5b can correct, at an early stage, frame timing in a subframe including first and second synchronization signals, with the time required to determine a synchronization error being secured.

Assuming that the head of the subframe #0 before correction is at timing T3, the synchronization processing unit 5b first adjusts the value of the frame counter 5i (FIG. 15) such that the head of the subframe #0 comes at timing T4 which is shifted by the amount of the above-described error from the timing T3. By this, the transmission timing of the subframe #0 of the downlink signal from the femto BS 1b can be allowed to match the transmission timing of a subframe #1 of the downlink signal from the macro BS 1a.

By this, the synchronization processing unit 5b can allow the frame timing of the femto BS 1b which is the base station apparatus to match the frame timing of the macro BS 1a, making it possible to achieve synchronization. In addition, although in the above only synchronization of frame timing is described, a correction to carrier frequency is also made.

[2.5 For a Measurement Process and a Process of Changing the Way to Use a Resource Block (an Allocation Process)]

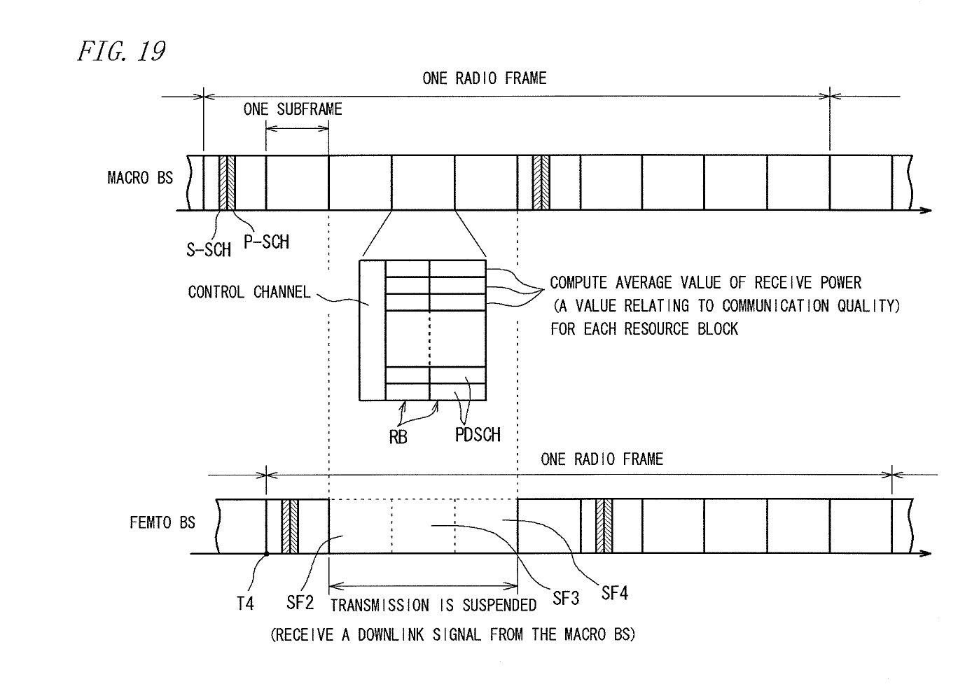

When the synchronization process in step S104 in FIG. 17 is performed, a measurement process starts. FIG. 19 is a diagram for describing an example of a mode of a measurement process performed by the measurement processing unit 5c. In FIG. 19, frames that are transmitted by a macro BS 1a which is another base station apparatus and a femto BS 1b which is a base station apparatus are shown on the same time axis, and a mode is shown in which the femto BS 1b performs a measurement process on a downlink signal from the macro BS 1a.

The measurement processing unit 5c can identify a subframe corresponding to the start timing of a synchronization process by the synchronization processing unit 5b, by synchronization timing information provided by the synchronization processing unit 5b.

The measurement processing unit 5c performs setting to perform a measurement process in a radio frame subsequent to a radio frame to which the identified subframe corresponding to the start timing of the synchronization process belongs. That is, as shown in the drawing, a measurement process is performed in a radio frame occurring immediately after achieving synchronization at timing T4.

The measurement processing unit 5c sets the start timing of a measurement process to a subframe SF2 in the drawing. In the present embodiment, the measurement processing unit 5c sets a section during which transmission of a downlink signal is suspended for a measurement process, to be three subframes starting from the subframe corresponding to the start timing to two subsequent subframes. Thus, the measurement processing unit 5c suspends, as shown in the drawing, transmission of a downlink signal during a section of subframes SF2, SF3, and SF4. The measurement processing unit 5c outputs measurement timing information including information for identifying the subframes SF2 to SF4, to the resource allocation control unit 5d.

While the measurement processing unit 5c suspends transmission of a downlink signal by the transmitting unit 13 during the section of the subframes SF2, SF3, and SF4, the measurement processing unit 5c allows the downlink signal receiving unit 12 to receive a downlink signal transmitted from the macro BS 1a to an MS 2a and thereby obtains the received downlink signal. Then, the measurement processing unit 5c determines resource blocks from the obtained downlink signal (step S105 in FIG. 17) and determines a power average value for each resource block (step S106).

As described above, since synchronization of frame timing has been achieved between the macro BS 1a and the base station apparatus (femto BS 1b), the frame timing of the macro BS 1a can be grasped. Thus, the measurement processing unit 5c can determine resource block units in the time-axis direction with a high accuracy and can determine power average values on a resource-block-by-resource-block basis with a high accuracy.

Therefore, it is preferred that a measurement process by the measurement processing unit 5c be performed immediately after performing a synchronization process. Hence, the measurement processing unit 5c sets timing at which a measurement process is performed, in accordance with synchronization timing information provided by the synchronization processing unit 5b. Specifically, the measurement processing unit 5c identifies a subframe in which a process for a synchronization process starts, based on received synchronization timing information (see SF1 in FIG. 18) and performs a measurement process in subframes (SF2, SF3, and SF4 in FIG. 19) belonging to a radio frame subsequent to a radio frame to which the identified subframe SF1 belongs.

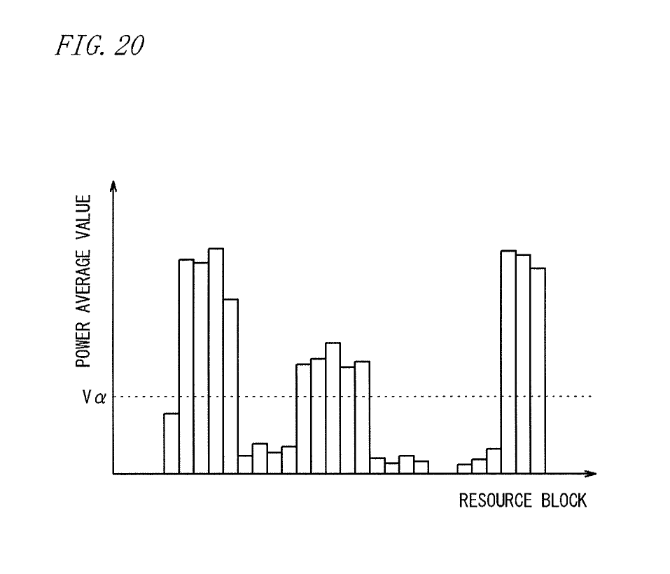

FIG. 20 is a diagram showing an example of the results of obtaining, by the measurement processing unit 5c, power average values for the respective resource blocks. In the drawing, a horizontal axis represents each resource block and a vertical axis represents a power average value.

As shown in this FIG. 20, in the resource blocks, some exhibit high power average values and some exhibit low power average values. It can be seen that in a resource block exhibiting a higher power average value which is determined by the measurement processing unit 5c than a threshold value Vα (Yes in step S107 in FIG. 17), data is allocated for communication between the macro BS 1a and the MS 2a, and thus, it can be estimated that the macro BS 1a is using the resource block for communication. Hence, the measurement processing unit 5c determines that this resource block cannot be used in a communication area of the base station apparatus (femto BS 1b). In this case, the resource allocation control unit 5d does not perform a resource block allocation process (step S108).

On the other hand, it can be seen that in a resource block exhibiting a lower power average value than the threshold value Vα (No in step S107 in FIG. 17), data for the MS 2a is not allocated, and thus, it can be estimated that the macro BS 1a is not using the resource block for communication. Hence, the measurement processing unit 5c determines that this resource block can be used in the communication area of the base station apparatus (femto BS 1b). In this case, the resource allocation control unit 5d starts an allocation process as a process of changing the way to use a resource block (step S109).

Specifically, in order to use, on a priority basis, resource blocks that are estimated not being used by the macro BS 1a, the resource allocation control unit 5d allocates data for communication between the base station apparatus (femto BS 1b) and an MS 2b, to the resource blocks. By this, the resource blocks used by the femto BS 1b can be avoided from overlapping the resource blocks used by the macro BS 1a and thus the occurrence of interference in the macro BS 1a and MS 2 connected to the macro BS 1a can be suppressed.

[2.6 For a Process of Determining Whether a Change to the Way to Use a Resource Block is Appropriate]

In step S107 in FIG. 17, the measurement processing unit 5c determines, based on a power average value for each resource block of the downlink signal between the macro BS 1a and the terminal apparatus 2a, whether each resource block can be used in the communication area of the base station apparatus (femto BS 1b). However, suppose the case where the determination made by the measurement processing unit 5c is wrong and a resource block is determined to be usable despite the fact that the resource block is not usable by the femto BS 1b, which will be described.

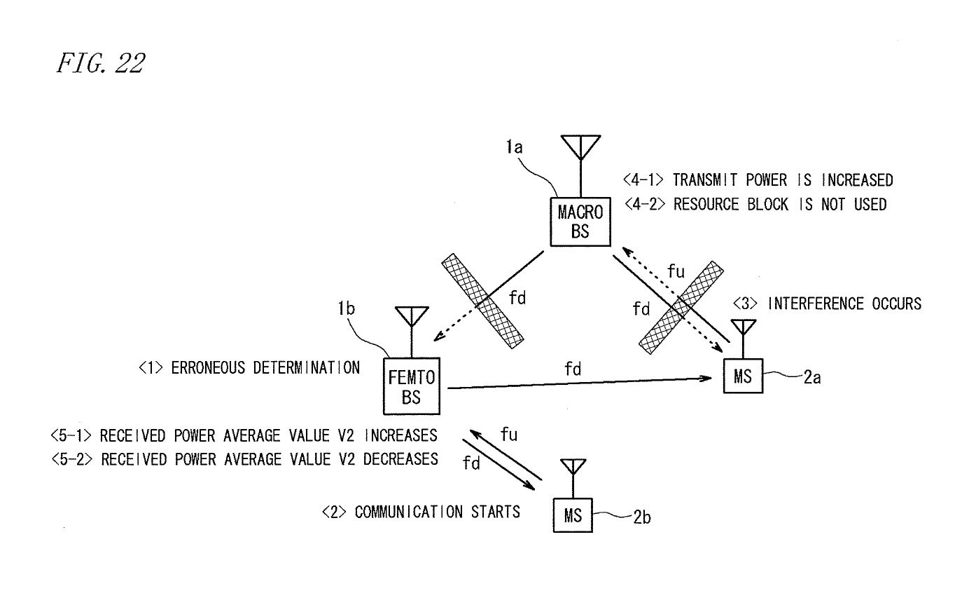

For such a case, an environment shown in FIG. 22 is considered. Specifically, it is the case where a radio signal is hard to reach between a macro BS 1a and a femto BS 1b. Furthermore, in FIG. 22, a radio signal is also temporarily hard to reach between the macro BS 1a and an MS 2a wirelessly connected to the macro BS 1. On the other hand, a radio signal is relatively easy to reach between the femto BS 1b and the MS 2a wirelessly connected to the macro BS1.

In this environment, for a resource block of a downlink signal between the macro BS 1a and the terminal apparatus 2a, even though the macro BS 1a and the terminal apparatus 2a are actually using the resource block for communication, a power average value V1 for the resource block of the downlink signal which is determined by the measurement processing unit 5c of the femto BS 1b may be smaller than the threshold value Vα. As a result, despite the fact that the resource block is supposed to be not usable by the femto BS 1b, the measurement processing unit 5c may erroneously determine that the resource block is usable (<1> in FIG. 22).

In this case, the resource allocation control unit 5d performs a process of allocating the resource block as an area used by a communication area of the femto BS 1b (step S109 in FIG. 17) and the femto BS 1b starts communication with a terminal apparatus 2b using the resource block (<2> in FIG. 22). As a result, a downlink signal from the femto BS 1b also reaches the terminal apparatus 2a and interference occurs in the terminal apparatus 2a (<3> in FIG. 22), deteriorating the communication state between the macro BS 1a and the terminal apparatus 2a. Hence, to improve the communication state, the macro BS 1a, for example, increases transmit power (<4-1> in FIG. 22). As a result, power in the resource block of a downlink signal transmitted from the macro BS 1a increases.

Note that when the measurement processing unit 5c erroneously determines that a certain resource block is usable by the femto BS 1b and accordingly communication is performed with the terminal apparatus 2b present in the communication area of the femto BS 1b, with transmit power in the resource block being increased by the communication condition control unit 5f, too, likewise, the communication state between the macro BS 1a and the terminal apparatus 2a deteriorates. Thus, in an attempt to improve the communication state, the macro BS 1a, for example, increases transmit power, ending up with the same result.

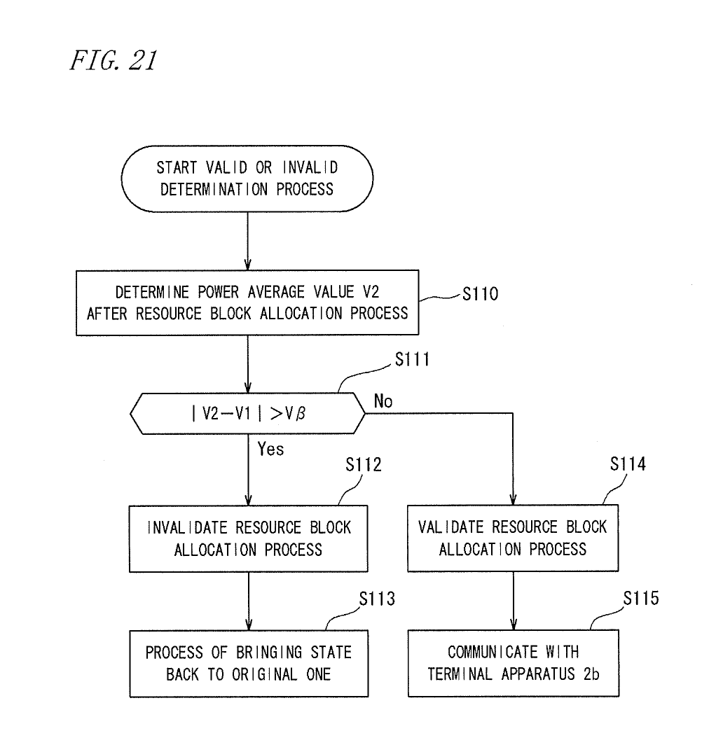

Subsequently, after the resource block allocation process in step S109 in FIG. 17, the femto BS 1b allows the measurement processing unit 5c to determine a power average value V2 for the resource block (step S110 in FIG. 21). Here, since the power in the resource block of the downlink signal transmitted from the macro BS 1a has increased, a power average value V2 for the resource block of the downlink signal received by the femto BS 1b has been changed in an increasing manner (<5-1> in FIG. 22).

Hence, the determination processing unit 5h determines the absolute value of a difference between the power average value V1 determined by the measurement processing unit 5c before the resource block allocation process in step S109 in FIG. 17 and the power average value V2 determined after the allocation process.

In the present embodiment, since the power average value V2 has been changed in an increasing manner, the absolute value of the difference between the power average values (V1−V2) exceeds a threshold value Vβ (Yes in step S111 in FIG. 21) and thus the determination processing unit 5h performs a process of invalidating the resource block allocation process (step S109 in FIG. 17) (step S112 in FIG. 21). Specifically, an instruction signal is provided to the resource allocation control unit 5d from the determination processing unit 5h and a process of bringing the state back to the one obtained before the resource block allocation, i.e., a process of bringing the state back to the one where the resource block is not used, is performed (step S113).

By the above, although a process of allowing a certain resource block to be used by the femto BS 1b is performed due to erroneous determination by the measurement processing unit 5c, the process is invalidated. Hence, the state can be brought back to the original one, making it possible to suppress the influence exerted on communication between the macro BS 1a and the terminal apparatus 2a.

As described above, in the femto BS 1b, due to erroneous determination by the measurement processing unit 5c, as shown in <4-1> in FIG. 22, the macro BS 1a performs a process of increasing transmit power in order to improve the communication state; however, aside from this process, the macro BS 1a may perform a process of changing resource block allocation so as not to use a corresponding resource block for communication with the terminal apparatus 2a <4-2>.

In this case, since the power in the resource block of the downlink signal transmitted from the macro BS 1a has decreased (no power), a power average value V2 for the resource block of the downlink signal received by the femto BS 1b has been changed in a decreasing manner (<5-2> in FIG. 22).

Hence, the determination processing unit 5h determines the absolute value of a difference between the power average value V1 determined by the measurement processing unit 5c before the resource block allocation process in step S109 in FIG. 17 and the power average value V2 determined after the allocation process.

In the present embodiment, since the power average value V2 has been changed in a decreasing manner, the absolute value of the difference between the power average values (V1−V2) is less than the threshold value V13 (No in step S111 in FIG. 21) and the determination processing unit 5h performs a process of validating the resource block allocation process (step S109 in FIG. 17) (step S114 in FIG. 21). Specifically, communication is performed with the terminal apparatus 2b present in the communication area of the femto BS 1b, using the resource block allocated in step S109 in FIG. 17 (step S115).

[2.7 For Other Processes]

When a macro BS 1a and an MS 2a wirelessly connected to the macro BS 1a continuously perform communication, as described above, a plurality of resource blocks arranged side by side in a consecutive manner in the time-axis direction are normally allocated to one same terminal apparatus. However, resource block allocation may become variable where due to, for example, an increase in the number of MS 2a in a macrocell MC, as a result of a resource allocation (user allocation) process by the macro BS 1a, as shown in FIG. 14, the allocation position in the frequency direction of a resource block allocated for a specific MS 2a frequently changes every subframe.

In such a variable case, even if the resource allocation control unit 5d allocates a resource block RBa which is determined by the measurement processing unit 5c to be not in use during a certain time period (a certain subframe; subframe #0 in FIG. 14), as a resource block to be used between the base station apparatus (femto BS 1b) and an MS 2b, the macro BS 1a may allocate the resource block RBa as an area for communication between the macro BS 1a and the MS 2a in later time periods (later subframes; subframes #5 and #9 in FIG. 14). In this case, interference may occur.

Hence, to suppress the occurrence of such interference, resource blocks allowed to be used by the MS 2a wirelessly connected to the macro BS 1a are allocated by the macro BS 1a on a subframe-by-subframe basis, and the allocation determining unit 5g determines whether this resource block allocation on a subframe-by-subframe basis is variable or fixed. Then, in accordance with a result of the determination, a process for performing communication with the MS 2b present in the femtocell FC is changed.

Note that allocation being variable refers to a state in which the allocation positions of resource blocks allocated to one same MS 2a are not in the same position but in different positions in the frequency direction. Namely, variable refers to the case where the degree of variations in allocation is higher than a preset threshold value.

On the other hand, allocation being fixed refers to a state in which the allocation positions of resource blocks allocated to one same MS 2a are in the same position in the frequency direction. Note that the same position includes the case where the degree of being in different positions is low. That is, being fixed refers to the case where the degree of variations in allocation is lower than the preset threshold value.

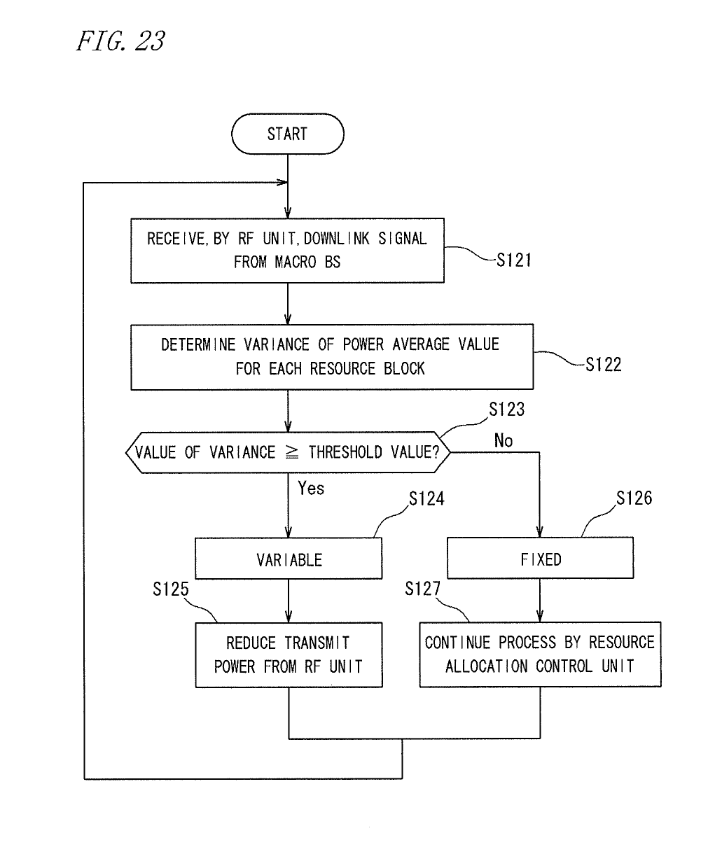

A determination process by the allocation determining unit 5g will be described. Resource blocks allowed to be used by an MS 2a wirelessly connected to the macro BS 1a are allocated by the macro BS 1a on a subframe-by-subframe basis and a downlink signal is transmitted from the macro BS 1a. As shown in FIG. 23, when the RF unit 4 of the femto BS 1b receives the downlink signal over time (step S121), the allocation determining unit 5g determines whether the allocation on a subframe-by-subframe basis is variable or fixed, based on a statistical value of a power average value for each resource block of the received downlink signal.

More specifically, the allocation determining unit 5g determines, as the statistical value, a variance of a power average value for each resource block (step S122). Then, if the value of the variance is greater than or equal to a preset threshold value (Yes in step S123), then it is considered that the power average value for the resource block has variations, i.e., it is found that resource blocks that are not used by the macro BS 1a vary from subframe to subframe, and thus, it can be determined that the resource block allocation is variable (step S124).

On the other hand, if the value of the variance is less than the threshold value (No in step S123), then it is considered that variations in power average value for the resource block are small, i.e., it is found that resource blocks that are not used by the macro BS 1a do not vary from subframe to subframe, and thus, it can be determined that the allocation is fixed (step S126).

Then, if it is determined by the allocation determining unit 5g that the allocation is fixed (step S126), then as described above, the resource allocation control unit 5d performs a process of allocating a resource block that is determined by the measurement processing unit 5c to be usable in the femtocell FC of the femto BS 1b, as an area used to communicate with an MS 2b present in the femtocell FC (step S127).

As such, when resource bock allocation by the macro BS 1a is fixed, a resource block determined to be usable is allocated as an area used to communicate with an MS 2b present in the femtocell FC and then communication can be performed with the MS 2b. Then, since the resource block determined to be usable is considered to be also usable later, interference does not occur in later resource blocks and thus the transmit power to the MS 2b does not need to be reduced, and furthermore, it is possible to avoid exerting an influence on communication between the macro BS 1a which is another base station apparatus and an MS 2a.

On the other hand, if it is determined by the allocation determining unit 5g that the allocation is variable (step S124), then the allocation determining unit 5g performs a process in which the transmit power of a signal to be transmitted from the RF unit 4 to an MS 2b present in the femtocell FC which is the communication area of the femto BS 1b is reduced to the extent that does not affect communication between the macro BS 1a and the MS 2a, and then communication is performed with the MS 2b in the femtocell FC (step S125). That is, the allocation determining unit 5g generates an instruction signal to reduce the transmit power of a signal to be transmitted from the RF unit 4, and the RF unit 4 performs a process of reducing the transmit power based on the instruction signal.

As such, when resource block allocation by the macro BS 1a is variable, resource blocks used by the femto BS 1b cannot be freely allocated based on a power average value for each resource block, but instead, resource blocks used by the femto BS 1b are arbitrarily allocated on the condition that the transmit power to an MS 2b present in the femtocell FC of the femto BS 1b is reduced to the extent that does not affect communication between the macro BS 1a and an MS 2a. By this, it is possible to avoid exerting an influence on (not to cause interference in) communication between the macro BS 1a which is another base station apparatus and the MS 2a.

In the present embodiment described above, the case is described in which the measurement processing unit 5c determines allocation of resource blocks based on a “downlink signal” which is transmitted by a macro BS 1a and received by the RF unit 4 of a base station apparatus (femto BS 1b) and determines, based on a power average value for each of the determined resource blocks, whether the resource block can be used in a communication area of the base station apparatus.

Here, it is also possible that the measurement processing unit 5c determines allocation of resource blocks based on an “uplink signal” from an MS 2a which is transmitted by the MS 2a to the macro BS 1a and received by the RF unit 4 of the base station apparatus (femto BS 1b) and determines, based on a power average value for each of the determined resource blocks, whether the resource block can be used in the communication area of the base station apparatus. This case will be described.

[2.8 For a Measurement Process in the Case of Using an Uplink Signal]

An uplink signal will be described.

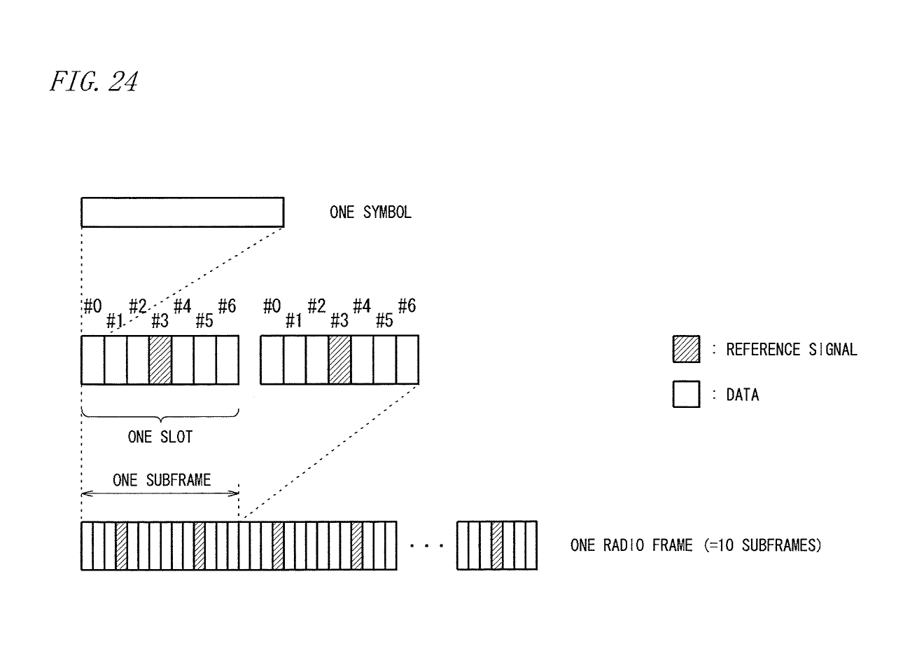

As described in FIG. 13, for radio frames on the uplink side in LTE (UL frames), each radio frame has a time length of 10 milliseconds and includes 10 subframes, #0 to #9 (each is a communication unit area having a fixed time length). FIG. 24 is a diagram showing a structure of a UL frame.

Each of the subframes forming a UL frame includes two slots. One slot includes seven OFDM symbols (#0 to #6) (in the case of Normal Cyclic Prefix).

A resource block (RB) which is a basic unit of resource allocation (the minimum unit of resource allocation) is defined as having 12 subcarriers in the frequency-axis direction and 7 OFDM symbols (#0 to #6; 1 slot) in the time-axis direction.

As a reference signal, a known signal is included in the fourth symbol (#3) in each slot (each resource block), and data of a terminal apparatus, etc., are stored in other areas (non-hatched areas in the drawing) of the resource block. Note that the femto BS 1b can also perform a synchronization process based on the uplink signal, by receiving and using the known signal included in the uplink signal.

A process in the case of using an uplink signal will be described. The configuration of a femto BS 1b for this process is the same as that in the above-described embodiment using a downlink signal (FIGS. 15 and 16). In the embodiment using a downlink signal, a measurement process is performed based on a downlink signal from another base station apparatus received by the downlink signal receiving unit 12; on the other hand, in the present embodiment using an uplink signal, a measurement process is performed based on an uplink signal from a terminal apparatus received by the uplink signal receiving unit 11. Specifically, the measurement processing unit 5c of the femto BS 1b performs a process of determining allocation of resource blocks based on an uplink signal received by the uplink signal receiving unit 11 in the RF unit 4, and determining whether the resource blocks can be used in a communication area of the femto BS 1b.

The uplink signal receiving unit 11 has the same configuration as the downlink signal receiving unit 12 (see FIG. 16), and a signal outputted from an A/D converting unit 117 included in the uplink signal receiving unit 11 is provided to the measurement processing unit 5c included in the signal processing unit 5 (see FIG. 15).

Note that a synchronization process may be performed based on a downlink signal from a macro BS 1a serving as a synchronization source which is received by the downlink signal receiving unit 12, by the same method as that described in the above-described embodiment using a downlink signal. However, since each terminal apparatus 2a performs communication with a synchronization process having been performed with the macro BS 1a, a synchronization process of the femto BS 1b may be performed based on an uplink signal from a terminal apparatus 2a received by the uplink signal receiving unit 11. In this case, too, the femto BS 1b can obtain a state of being synchronized with the macro BS 1a.

Since the macro BS 1a and an MS 2 being in a state of communicating with the macro BS 1a are synchronized with each other, if the femto BS 1b performs a synchronization process with the macro BS 1a, then the femto BS 1b goes into a state of being synchronized with the MS 2. Hence, in the femto BS 1b, the measurement processing unit 5c can extract portions determined to be resource block units from an uplink signal obtained by the uplink signal receiving unit 11 such that the portions are separated in the time-axis direction (and the frequency-axis direction). Hence, by the same method as that in the embodiment using a downlink signal, the measurement processing unit 5c can determine the extracted portions to be resource blocks. Then, even if the aforementioned resource allocation information cannot be grasped, by determining a power average value for each resource block, it can be determined whether the resource block can be used in a communication area of the femto BS 1b.

Although, in the embodiment using a downlink signal, the femto BS 1b needs to suspend transmission of a downlink signal upon a measurement process, in the embodiment using an uplink signal, the femto BS 1b does not need to suspend transmission of a downlink signal. This is because the frequency of a downlink signal transmitted by the RF unit 4 of the femto BS 1b differs from the frequency of an uplink signal received by the RF unit 4.

Receive power of uplink signals in the femto BS 1b may include power of an uplink signal from an MS 2b present in a femtocell FC of the base station apparatus (femto BS 1b) and of an uplink signal from an MS 2a present in a macrocell MC of the macro BS 1. However, the receive power of the uplink signal from the MS 2b present in the femtocell FC of the base station apparatus (femto BS 1b) can be estimated based on the transmit power of the uplink signal (a pilot signal) and the characteristics of a transmission line at that point in time. Hence, by deducting the estimated receive power from the receive power of the uplink signals in the femto BS 1b, only the power of the uplink signal from the MS 2a present in the macrocell MC of the macro BS 1a can be determined and thus a measurement process can be performed.

Furthermore, in the case of using an uplink signal, too, the determination processing unit 5h has the function of determining whether the way to use a resource block by the changing unit 5e is appropriate, and further invalidating or validating the change to the way to use a resource block.

[2.9 Regarding Base Station Apparatuses (Femto BS 1b) According to the Embodiments]

According to base station apparatuses (femto BS 1b) according to the above-described embodiments, by the synchronization processing unit 5b performing a process for synchronizing with a macro BS 1a (another base station apparatus), resource blocks included in signals received by the RF unit 4 can be determined.

Then, the RF unit 4 receives a downlink signal (or an uplink signal) between the macro BS 1a and an MS 2a wirelessly connected to the macro BS 1a, and the measurement processing unit 5c determines, based on the received signal, a power average value of the receive signal for each resource block and can determine, based on the power average value, whether the resource block can be used in a communication area of the femto BS 1b.

If, as a result of the determination, a power average value for a certain resource block is large, then it can be estimated that the resource block is being used for communication between the macro BS 1a and the MS 2a. Thus, the femto BS 1b can refrain from communicating with an MS 2 using the resource block. Hence, the influence exerted on communication of the macro BS 1a can be suppressed.

In contrast to this, if a power average value for a certain resource block is small, then it can be estimated that the resource block is not being used for communication between the macro BS 1a and the MS 2a. Thus, in order to communicate with an MS 2b using the resource block, the femto BS 1b can allocate the resource block for its own communication. Hence, the femto BS 1b can secure its communication opportunities.

In addition, a base station apparatus (femto BS 1b) of the present invention for the case of using, for a measurement process, a downlink signal transmitted from another base station apparatus (macro BS la) to a terminal apparatus 2 includes a transmitting/receiving unit (RF unit 4) that can receive a downlink signal transmitted from another base station apparatus (macro BS 1a) to a terminal apparatus 2a wirelessly connected to the another base station apparatus (macro BS 1a) and that transmits a downlink signal to a terminal apparatus 2b present in a communication area of the base station apparatus (femto BS 1b); and a measurement processing unit 5c that determines power in each resource block of the downlink signal received by the transmitting/receiving unit and determines, based on the power, whether the resource block can be used in the communication area of the base station apparatus. The base station apparatus (femto BS 1b) of the present invention is characterized in that the measurement processing unit 5c determines whether resource blocks can be used in the communication area of the base station apparatus, based on the power of a downlink signal received by the transmitting/receiving unit, with transmission of a downlink signal by the transmitting/receiving unit being temporarily suspended.

According to the base station apparatus of the present invention, resource blocks usable by the base station apparatus (femto BS 1b) can be determined without obtaining the aforementioned resource allocation information included in a downlink signal from another base station apparatus (macro BS 1a).

However, at this time, downlink signals received by the transmitting/receiving unit may include a downlink signal transmitted by the base station apparatus to a terminal apparatus 2b present in the communication area of the base station apparatus (femto BS 1b), in addition to a downlink signal transmitted from another base station apparatus (macro BS 1a) to a terminal apparatus 2a. As a result, when the measurement processing unit 5c makes the above-described determination based on the power of a downlink signal, a downlink signal transmitted by the base station apparatus may become trouble.

In view of this, according to the above-described configuration of the present invention, by brining transmission of a downlink signal by the transmitting/receiving unit to a temporarily suspended state, the measurement processing unit 5c can make the above-described determination based on a downlink signal transmitted from another base station apparatus (macro BS 1a) to a terminal apparatus 2a and received by the transmitting/receiving unit, making it possible to prevent the above-described trouble.

Note that in the above-described embodiments, upon a measurement process, power in each resource block is determined; at this time, a pilot subcarrier, a data subcarrier, or both of those signals can be used.

Note also that the present invention is not limited to the above-described embodiments.

The above-described embodiments describe that in a process in which the measurement processing unit 5c determines, based on power, whether a certain resource block can be used in the communication area of the base station apparatus (femto BS 1b), a resource block with small power is not being used for communication between the macro BS 1a and an MS 2a wirelessly connected thereto. However, for a resource block with small power which is usable by the femto BS 1b, in addition to this, a resource block which is used for communication between the macro BS 1a and an MS 2a wirelessly connected thereto but whose communication signal is extremely weak and thus has small power which is determined by the measurement processing unit 5c of the femto BS 1b may also be determined to be usable in the communication area of the base station apparatus (femto BS 1b).

According to [Chapter 2] in the present invention, basic units of resource allocation usable by a base station apparatus of the present invention can be determined without obtaining resource allocation information included in a communication signal transmitted from another base station apparatus, and communication can be appropriately performed with a terminal apparatus present in a communication area of the base station apparatus, using the basic units of the resource allocation.

[Chapter 3]

Base station apparatuses described in Chapter 3 adopt techniques relating to the base station apparatuses described in Chapter 1 or 2 within the scope in which they do not technically contradict. In this Chapter 3, for those points that are not particularly described, the matters described in Chapters 1 and 2 are incorporated.

[3.1 For Another Base Station Apparatus]

Each of the above-described embodiments in Chapters 1 and 2 describes the case where a measurement processing unit 5c of a femto base station 1b determines “power” in a resource block (a basic unit of resource allocation) of a communication signal received by an RF unit 4 and determines, based on the “power”, whether the resource block can be used in a communication area of the femto base station 1b.

However, the measurement processing unit 5 may use “communication quality” instead of “power” in a resource block. Note that the values relating to “communication quality” include an SN ratio and an SINR, and in this case the “communication quality” is based on “power”. In general, the relationship therebetween is such that when the power in a resource block is high the communication quality is also high, and when the power is low the communication quality is also low.

Note that when using “power” in a resource block, the “power” is the total value of powers from other base station apparatuses, but when using “communication quality”, the “communication quality” is the value of communication quality of each individual other base station apparatus.

A configuration of a signal processing unit 5 of the femto base station 1b in this case is the same as that in FIG. 4, but in this case, the measurement processing unit 5c determines communication quality in a resource block of a communication signal (downlink signal) which is transmitted by another base station apparatus 1a and received by the RF unit 4 of the base station apparatus (femto base station 1b). The measurement processing unit 5c further determines, based on the communication quality, whether the resource block can be used in the communication area of the femto base station 1b.

Furthermore, with transmission of a downlink signal by the RF unit 4 being temporarily suspended, the measurement processing unit 5c determines whether the resource block can be used in the communication area of the femto base station 1b, based on the communication quality of the downlink signal received by the RF unit 4.

This femto base station 1b will be further described. As with the description made using FIG. 8, the measurement processing unit 5c suspends transmission of a downlink signal by a transmitting unit 13 during a subframe section (SF2, SF3, and SF4 in FIG. 8) corresponding to the timing at which a downlink signal is obtained for a measurement process and which is set by itself (the start timing of a measurement process). Then, a measurement process starts in this suspended state.

While transmission of a downlink signal is suspended, the measurement processing unit 5c allows a downlink signal receiving unit 12 to receive a downlink signal from another base station apparatus (macro BS la) and thereby obtains the received downlink signal. Thereafter, values relating to communication quality in the resource blocks of the downlink signal are measured and the magnitude of the value relating to communication quality for each resource block is compared with a threshold value, whereby the usage state of the resource block is estimated and it is determined whether the resource block can be used in the communication area of the base station apparatus (a measurement process).

That is, when another base station apparatus (macro BS 1a) performs communication with a terminal apparatus 2a in its macrocell MC, data destined for the terminal apparatus 2a is allocated to the communication signal and the communication quality in a resource block to which the data is allocated tends to be relatively high compared with that in a resource block to which the data is not allocated. By this, without grasping the aforementioned resource allocation information, it can be determined, based on the communication quality of the communication signal, whether a certain resource block is being used to perform communication between another base station apparatus (macro BS 1a) and the terminal apparatus 2a.

Hence, the measurement processing unit 5c determines, in the above-described manner, resource blocks from a downlink signal obtained by the downlink signal receiving unit 12 and determines an average value of the value relating to communication quality for each of the determined resource blocks. Note that the average value is a value for each of other base station apparatuses.

Then, the measurement processing unit 5c compares the value relating to communication quality (average value) with a preset threshold value. If the value relating to communication quality (average value) is greater, then it can be determined that the resource block is in use. As a result, it is determined that the resource block cannot be used for the femto base station 1b (cannot be used in the communication area of the femto base station 1b).

That is, since the average value for each resource block is a value for each of other base station apparatuses, if, as a result of comparing an average value for each of other base station apparatuses with the threshold value, the average value for even one of the other base station apparatuses is greater than the threshold value, then it can be determined that the resource block is in use and thus it is determined that the resource block cannot be used for the femto base station 1b.

On the other hand, if the determined value relating to communication quality (average value) is smaller than the threshold value, then it can be determined that the resource block is not in use. As a result, it is determined that the resource block can be used for the femto base station 1b (can be used in the communication area of the femto base station 1b).

That is, since the average value for each resource block is a value for each of other base station apparatuses, if, as a result of comparing an average value for each of other base station apparatuses with the threshold value, the average values for all of the other base station apparatuses are smaller than the threshold value, then it can be determined that the resource block is not in use and thus it is determined that the resource block can be used for the femto base station 1b.

As such, without grasping the aforementioned resource allocation information, a measurement process can determine, based on the communication quality for each resource block, whether the resource block can be used in the communication area of the femto base station 1b.

Note that although the above describes the case of the “average value of communication quality”, the “maximum value of communication quality” may be used.

When an average value is adopted, the average value may be an average value in a single resource block but is preferably an average value for a plurality of resource blocks included in a single subframe or a plurality of consecutive subframes. This is because, as described above, a plurality of resource blocks arranged side by side in a consecutive manner in a time-axis direction are normally allocated to one same terminal apparatus, and thus an average value for a plurality of resource blocks can be adopted.

[3.2 For a Still Another Base Station Apparatus]

Furthermore, Chapter 2 describes the case where a determination processing unit 5h of a femto base station 1b determines, based on a difference between “powers” in a resource block before and after a change to the way to use a resource block which are determined by a measurement processing unit 5c before and after the change, whether the change to the way to use is appropriate.

However, the determination processing unit 5h may use “communication quality” instead of “power” in a resource block.

Note that in this case, too, when “power” in a resource block is used, the “power” is the total value of powers from other base station apparatuses, but when using “communication quality”, the “communication quality” is the value of communication quality of each individual other base station apparatus.

A configuration of a signal processing unit 5 of the femto base station 1b in this case is the same as that in FIG. 15, but in this case, the measurement processing unit 5c determines communication quality in a resource block of a communication signal (downlink signal) which is transmitted by another base station apparatus 1a and received by an RF unit 4 of the base station apparatus (femto base station 1b). The measurement processing unit 5c further determines, based on the communication quality, whether the resource block can be used in a communication area of the femto base station 1b. The process performed by the measurement processing unit 5c is the same as that described above.

Then, a changing unit 5e changes, based on a result of the determination by the measurement processing unit 5c, the way to use a resource block in order to communicate with a terminal apparatus 2b present in the communication area of the femto base station 1b.

Furthermore, based on a difference between communication qualities in the resource block before and after the change to the way to use made by the changing unit 5e which are determined by the measurement processing unit 5c before and after the change, the determination processing unit 5h determines whether the change to the way to use is appropriate.

This femto base station 1b will be further described. As with the case of FIG. 15, the changing unit 5e has the function of changing the way to use a resource block (a communication parameter relating to the way to use a resource block) in order to communicate with a terminal apparatus 2b present in the communication area of the femto base station 1b. That is, the changing unit 5e includes a resource allocation control unit 5d having a resource allocation function that performs resource block allocation; and a communication condition control unit 5f having a communication condition control function that controls a communication condition, such as transmit power, used when performing wireless communication.

That is, the changing unit 5e changes the way to use a resource block based on a result of determination by the measurement processing unit 5c, in order to communicate with a terminal apparatus 2b present in the communication area of the femto base station 1b. The change to the way to use a resource block is one or both of the following: a process of allocating a usable resource block as an area used by the femto base station 1b and a process of changing transmit power in a resource block used by the femto base station 1b. These processes are as described in Chapter 2.

The determination processing unit 5h has the function of determining whether a change to the way to use a resource block made by the changing unit 5e is appropriate.

To allow the determination processing unit 5h to function, the above-described communication qualities before and after the change to the way to use a resource block made by the changing unit 5e are determined by the measurement processing unit 5c. Then, the determination processing unit 5h determines a difference (the absolute value of a difference) between an average value V1 of the value relating to communication quality determined by the measurement processing unit 5c before the change to the way to use a resource block and an average value V2 of the value relating to communication quality determined after the change to the way to use a resource block. Then, in the determination processing unit 5h, a threshold value Vr3 for the difference between the average values is set. If the absolute value of the difference (V1−V2) between the average values of the value relating to communication quality before and after the change to the way to use a resource block exceeds the threshold value Vβ, then the determination processing unit 5h determines that the change to the way to use a resource block is inappropriate, and thus, performs a process of invalidating the change to the way to use. The process of invalidating the change is a process of allowing the changing unit 5e to perform a process of bringing the state back to the one obtained before the change, by an instruction signal from the determination processing unit 5h.

On the other hand, if the absolute value of the difference (V1−V2) between the average values of the value relating to communication quality before and after the change to the way to use a resource block is less than or equal to the threshold value Vβ, then the determination processing unit 5h determines that the change to the way to use a resource block is appropriate, and thus, performs a process of validating the change to the way to use a resource block. The process of validating the change is a process of maintaining the state obtained after the change, and the RF unit 4 communicates with a terminal apparatus 2b present in the communication area of the femto base station 1b, by the changed way to use a resource block.

[3.3 For a Variant of the Resource Allocation Control Unit]

The embodiments in the above-described chapters describe that a measurement processing unit 5c of a femto base station 1b determines power (or communication quality) in a resource block of a communication signal which is transmitted from another base station apparatus (1a) and received by an RF unit 4 and if it is determined, based on the power (or communication quality), that the resource block cannot be used in a communication area of the femto base station 1b, then a resource allocation control unit 5d does not perform a process of allocating the resource block for the femto base station 1b (step S8 in FIG. 6). However, even if the measurement processing unit 5c has thus made a determination, the resource allocation control unit 5d may perform a process of allocating the resource block for the femto base station 1b on the condition that transmit power from the RF unit 4 is reduced.

Specifically, even when the measurement processing unit 5c determines that a resource block cannot be used in the communication area of the femto base station 1b, the resource allocation control unit 5d generates an instruction signal for reducing the transmit power of signals to be transmitted from the RF unit 4, and the RF unit 4 performs a process of reducing the transmit power based on the instruction signal.

By this, the femto base station 1b can perform communication with a terminal apparatus 2b in its communication area, using the resource block and can moreover avoid exerting an influence on (causing interference in) communication between another base station apparatus 1a and a terminal apparatus 2a wirelessly connected to the base station apparatus 1a.

Note that the reduction in transmit power in this case is such that the transmit power is reduced to the extent that does not affect communication between another base station apparatus 1a and a terminal apparatus 2a wirelessly connected to the base station apparatus 1a.

In addition, the transmit power is reduced in accordance with the level of power (average value) or communication quality (average value) determined by the measurement processing unit 5c. That is, control is performed such that the higher the power (average value) or communication quality (average value), the greater the level of reduction in transmit power.

Furthermore, although the above describes the case of the “average value” of power or communication quality, the “maximum value” of power or communication quality may be used.

[3.4 For a Measurement Process]

In the above-described embodiments in Chapters 1 and 2, when a downlink signal from another base station apparatus is used, receive power of downlink signals in a femto base station 1b may include power of a downlink signal transmitted by the femto base station 1b and of a downlink signal transmitted by a macro base station 1. Hence, in the femto base station 1b, a measurement processing unit performs a measurement process with transmission of a downlink signal being temporarily suspended.

However, the receive power of the downlink signal from the base station apparatus (femto base station 1b) can be estimated based on the transmit power of the downlink signal (a pilot signal) and the characteristics of a transmission line at that point in time. Hence, without performing suspension such as that described above, by deducting the estimated receive power from the receive power of the downlink signals in the femto base station 1b, only the power of the downlink signal from the macro base station 1a can be determined and thus a measurement process can be performed.

The embodiments disclosed herein are illustrative of the present invention and not restrictive. The scope of the present invention is indicated by the appended claims and all changes that come within the meanings and the range of equivalency of the claims are embraced therein.

### REFERENCE SIGNS LIST

1a: MACRO BASE STATION (ANOTHER BASE STATION)
1b: FEMTO BASE STATION
2: TERMINAL APPARATUS
4: RF UNIT (TRANSMITTING/RECEIVING UNIT)
5b: SYNCHRONIZATION PROCESSING UNIT
5c: MEASUREMENT PROCESSING UNIT
5d: RESOURCE ALLOCATION CONTROL UNIT
5e: CHANGING UNIT
5f: COMMUNICATION CONDITION CONTROL UNIT
5g: ALLOCATION DETERMINING UNIT
5h: DETERMINATION PROCESSING UNIT
11: UPLINK SIGNAL RECEIVING UNIT (RECEIVING UNIT)
12: DOWNLINK SIGNAL RECEIVING UNIT (RECEIVING UNIT)

1. A base station apparatus that communicates with a terminal apparatus present in a communication area thereof, using a plurality of basic units of resource allocation into which a radio frame is divided in a time-axis direction and in a frequency-axis direction, the base station apparatus comprising:
a receiving unit that receives a communication signal between another base station apparatus and a terminal apparatus wirelessly connected to the another base station apparatus;
a synchronization processing unit that performs a process for synchronizing with the another base station apparatus; and
a measurement processing unit that determines, based on the communication signal received by the receiving unit, power in each of a plurality of basic units of resource allocation into which a radio frame is divided in a time-axis direction and in a frequency-axis direction of the communication signal and determines, based on the power, whether each of the plurality of basic units of resource allocation into which the radio frame is divided in the time-axis direction and in the frequency-axis direction can be used in the communication area of the base station apparatus.

2. The base station apparatus according to claim 1, comprising a resource allocation control unit that allocates the basic unit of resource allocation determined by the measurement processing unit to be usable in the communication area of the base station apparatus, as an area used to communicate with the terminal apparatus present in the communication area of the base station apparatus.

3. The base station apparatus according to claim 2, comprising a communication condition control unit that controls a communication condition used when performing wireless communication using the basic unit of resource allocation allocated by the resource allocation control unit.

4. The base station apparatus according to claim 1, wherein
the synchronization processing unit starts the process for synchronization in a first cycle, and
the measurement processing unit determines, based on the power, whether the basic unit of resource allocation can be used in the communication area of the base station apparatus, in a second cycle different than the first cycle.

5. The base station apparatus according to claim 1, wherein the measurement processing unit determines, based on the power, whether the basic unit of resource allocation can be used in the communication area of the base station apparatus, after starting the process for synchronization performed by the synchronization processing unit.

6. The base station apparatus according to claim 1, wherein the communication signal received by the receiving unit so as to be used by the measurement processing unit is a downlink signal transmitted by the another base station apparatus to the terminal apparatus wirelessly connected to the another base station apparatus.

7. The base station apparatus according to claim 1, wherein the communication signal received by the receiving unit so as to be used by the measurement processing unit is an uplink signal transmitted by the terminal apparatus wirelessly connected to the another base station apparatus to the another base station apparatus.

8. The base station apparatus according to claim 2, comprising an allocation determining unit that determines, based on the communication signal transmitted such that allocation of basic units of resource allocation is performed by the another base station apparatus, whether the allocation is variable or fixed.

9. The base station apparatus according to claim 8, wherein when the allocation determining unit determines that the allocation is fixed, the resource allocation control unit allocates the basic unit of resource allocation determined by the measurement processing unit to be usable in the communication area of the base station apparatus, as an area used to communicate with the terminal apparatus present in the communication area of the base station apparatus.

10. The base station apparatus according to claim 8, wherein when the allocation determining unit determines that the allocation is variable, the allocation determining unit allows performing communication with transmit power to a terminal apparatus present in the communication area of the base station apparatus being reduced.

11. The base station apparatus according to claim 8, wherein the allocation determining unit determines whether the allocation is variable or fixed, based on a statistical value of power in the basic unit of resource allocation of the communication signal received by the receiving unit.

12. A base station apparatus that communicates with a terminal apparatus present in a communication area thereof, using a plurality of basic units of resource allocation into which a radio frame is divided in a time-axis direction and in a frequency-axis direction, the base station apparatus comprising:
a transmitting/receiving unit that can receive a downlink signal transmitted from another base station apparatus to a terminal apparatus wirelessly connected to the another base station apparatus and that transmits a downlink signal to the terminal apparatus present in the communication area of the base station apparatus; and
a measurement processing unit that determines, based on the downlink signal received by the transmitting/receiving unit, power in each of a plurality of basic units of resource allocation into which a radio frame is divided in a time-axis direction and in a frequency-axis direction of the downlink signal and determines, based on the power, whether each of the plurality of basic units of resource allocation into which the radio frame is divided in the time-axis direction and in the frequency-axis direction can be used in the communication area of the base station apparatus, wherein
with transmission of the downlink signal by the transmitting/receiving unit being temporarily suspended, the measurement processing unit determines, based on the power of the downlink signal received by the transmitting/receiving unit, whether each of the plurality of basic units of resource allocation into which the radio frame is divided in the time-axis direction and in the frequency-axis direction can be used in the communication area of the base station apparatus.

13. A base station apparatus that communicates with a terminal apparatus present in a communication area thereof, using a plurality of basic units of resource allocation into which a radio frame is divided in a time-axis direction and in a frequency-axis direction, the base station apparatus comprising:
a receiving unit that receives a communication signal between another base station apparatus and a terminal apparatus wirelessly connected to the another base station apparatus;
a synchronization processing unit that performs a process for synchronizing with the another base station apparatus; and
a measurement processing unit that determines, based on the communication signal received by the receiving unit, communication quality in each of a plurality of basic units of resource allocation into which a radio frame is divided in a time-axis direction and in a frequency-axis direction of the communication signal and determines, based on the communication quality, whether each of the plurality of basic units of resource allocation into which the radio frame is divided in the time-axis direction and in the frequency-axis direction can be used in the communication area of the base station apparatus.

14. A base station apparatus that communicates with a terminal apparatus present in a communication area thereof, using a plurality of basic units of resource allocation into which a radio frame is divided in a time-axis direction and in a frequency-axis direction, the base station apparatus comprising:
a transmitting/receiving unit that can receive a downlink signal transmitted from another base station apparatus to a terminal apparatus wirelessly connected to the another base station apparatus and that transmits a downlink signal to the terminal apparatus present in the communication area of the base station apparatus; and
a measurement processing unit that determines, based on the downlink signal received by the transmitting/receiving unit, communication quality in each of a plurality of basic units of resource allocation into which a radio frame is divided in a time-axis direction and in a frequency-axis direction of the downlink signal and determines, based on the communication quality, whether each of the plurality of basic units of resource allocation into which the radio frame is divided in the time-axis direction and in the frequency-axis direction can be used in the communication area of the base station apparatus, wherein
with transmission of the downlink signal by the transmitting/receiving unit being temporarily suspended, the measurement processing unit determines, based on the communication quality of the downlink signal received by the transmitting/receiving unit, whether each of the plurality of basic units of resource allocation into which the radio frame is divided in the time-axis direction and in the frequency-axis direction can be used in the communication area of the base station apparatus.

15. A base station apparatus that communicates with a terminal apparatus present in a communication area thereof, using a plurality of basic units of resource allocation into which a radio frame is divided, the base station apparatus comprising:
a transmitting/receiving unit that receives a communication signal between another base station apparatus and a terminal apparatus wirelessly connected to the another base station apparatus and that is to communicate with the terminal apparatus present in the communication area of the base station apparatus;
a synchronization processing unit that performs a process for synchronizing with the another base station apparatus;
a measurement processing unit that determines power in each basic unit of resource allocation of the communication signal received by the transmitting/receiving unit and determines, based on the power, whether the basic unit of resource allocation can be used in the communication area of the base station apparatus;
a changing unit that can change, based on a result of the determination by the measurement processing unit, a way to use the basic unit of resource allocation in order to communicate with the terminal apparatus present in the communication area of the base station apparatus; and
a determination processing unit that determines whether the change to the way to use is appropriate, based on a difference between powers in the basic unit of resource allocation before and after the change, the powers being determined by the measurement processing unit before and after the change to the way to use made by the changing unit.

16. The base station apparatus according to claim 15, wherein when the difference between powers before and after the change to the way to use the basic unit of resource allocation made by the changing unit exceeds a threshold value, the determination processing unit determines that the change to the way to use is inappropriate and thus performs a process of invalidating the change to the way to use.

17. The base station apparatus according to claim 15, wherein
when the difference between powers before and after the change to the way to use the basic unit of resource allocation made by the changing unit is less than or equal to the threshold value, the determination processing unit determines that the change to the way to use is appropriate and thus performs a process of validating the change to the way to use, and
the transmitting/receiving unit communicates with the terminal apparatus present in the communication area of the base station apparatus, by the way to use the basic unit of resource allocation having been changed by the changing unit.

18. The base station apparatus according to claim 15, wherein the changing unit has a resource allocation function for changing the way to use the basic unit of resource allocation, and the resource allocation function allocates the basic unit of resource allocation determined by the measurement processing unit to be usable in the communication area of the base station apparatus, as an area used to communicate with the terminal apparatus present in the communication area of the base station apparatus.

19. The base station apparatus according to claim 15, wherein the changing unit has a communication condition control function for changing the way to use the basic unit of resource allocation, and the communication condition control function increases transmit power of a signal to be transmitted to the terminal apparatus from the transmitting/receiving unit, in the basic unit of resource allocation determined by the measurement processing unit to be usable in the communication area of the base station apparatus.

20. A base station apparatus that communicates with a terminal apparatus present in a communication area thereof, using a plurality of basic units of resource allocation into which a radio frame is divided, the base station apparatus comprising:
a transmitting/receiving unit that receives a communication signal between another base station apparatus and a terminal apparatus wirelessly connected to the another base station apparatus and that is to communicate with the terminal apparatus present in the communication area of the base station apparatus;
a synchronization processing unit that performs a process for synchronizing with the another base station apparatus;
a measurement processing unit that determines communication quality in each basic unit of resource allocation of the communication signal received by the transmitting/receiving unit and determines, based on the communication quality, whether the basic unit of resource allocation can be used in the communication area of the base station apparatus;
a changing unit that can change, based on a result of the determination by the measurement processing unit, a way to use the basic unit of resource allocation in order to communicate with the terminal apparatus present in the communication area of the base station apparatus; and
a determination processing unit that determines whether the change to the way to use is appropriate, based on a difference between communication qualities in the basic unit of resource allocation before and after the change, the communication qualities being determined by the measurement processing unit before and after the change to the way to use made by the changing unit.

21. The base station apparatus according to claim 1, further comprising a frame counter for determining transmission timing for each radio frame of the communication signal.

22. The base station apparatus according to claim 21, wherein the synchronization processing unit detects an error between transmission timing of a radio frame of the another base station apparatus and transmission timing of a radio frame of the base station apparatus, and corrects frame timing in accordance with the error by adjusting the frame counter.

23. The base station apparatus according to claim 13, further comprising a frame counter for determining transmission timing for each radio frame of the communication signal.

24. The base station apparatus according to claim 15, further comprising a frame counter for determining transmission timing for each radio frame of the communication signal.

25. The base station apparatus according to claim 20, further comprising a frame counter for determining transmission timing for each radio frame of the communication signal.
